(19) United States
(12) Patent Application Publication
(10) Pub. No.: US 2005/0099628 A1
(43) Pub. Date: May 12, 2005

(54) Mark for position detection, mark identification method, position detection method, exposure method, and positional information detection method

(75) Inventor: Yuuji Kokumai, Ageo-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/950,450

(22) Filed: Sep. 28, 2004

Related U.S. Application Data
(63) Continuation of application No. PCT/JP03/04019, filed on Mar. 28, 2003.

(30) Foreign Application Priority Data
Mar. 29, 2002 (JP) P 2002-095562
Aug. 22, 2002 (JP) P 2002-242457

(51) Int. Cl. G01B 11/00

(52) U.S. Cl. 356/401

(57) ABSTRACT

The present invention proposes a mark for position detection which can reliably detect a mark which is the subject of detection, even when a large number of marks of the same type are present in the vicinity of this mark which is to be the subject of detection. A mark for position detection 10, which is provided upon a photosensitive substrate P, and which is used when detecting positional information for the photosensitive substrate P by an alignment optical system 9, comprises an alignment mark 1 for outputting positional information to a control device CONT by being observed by the alignment optical system 9, and a identification mark 2 which is arranged in a predetermined positional relationship with the alignment mark 1, consists of a combination of four patterns of three types, and expresses 3⁴ types of information.

### TECHNICAL FIELD

### BACKGROUND OF THE INVENTION

1. Field of the Invention

The present invention relates: to a mark for position detection, which is provided upon an object, and which is used when detecting positional information of this object; to a mark identification method and a mark detection method for identifying a specific mark from a plurality of marks; to an exposure method, in which a pattern upon a substrate is exposed to light; and to a positional information detection method.

2. Description of Related Art

A micro device such as a semiconductor element or a liquid crystal display element or the like is manufactured by repeating each of a film manufacture processing process, a processing for exposure to light process, and an etching processing process and the like a plurality of times, thus layering a plurality of patterns upon a substrate. In this processing for exposure to light, an exposure device is utilized for transcribing a pattern which is formed upon the mask to a substrate upon which a photosensitive material is applied. This exposure device comprises a mask stage which supports the mask and shifts it in two dimensions, and a substrate stage which supports the photosensitive substrate and shifts it in two dimensions; and the pattern upon the mask is transcribed to the photosensitive substrate while sequentially shifting the mask stage and the substrate stage. Since, in the processing for exposure to light, it is necessary to superimpose the image of the pattern which must be next superimposed upon the pattern which is already formed upon the substrate with good accuracy, accordingly alignment is performed between the shot region upon the substrate and the mask which has the pattern for the subsequent layer.

Normally, in the alignment procedure for the substrate, there are performed: a pre-alignment procedure, which is a preliminary positional alignment when the substrate is loaded upon the substrate stage; a search alignment procedure in which, in the state with the substrate supported upon the substrate stage, a rough positional alignment is performed by using two or three search marks which are provided upon the substrate; and a fine alignment procedure in which, using the result of the search alignment procedure, the substrate is finely positionally aligned. Among these, in the fine adjustment procedure, a deviation and a rotation and the like of the substrate in the two dimensional directions (the plane direction, the XY direction) with respect to a standard position are obtained from the result of the search alignment, and, based upon these, the position of the design upon each shot region (alignment mark), and the position (the measured value or the calculated value) which was used for the pattern transcription for the previous layer are compensated, the alignment marks are guided within the measurement region of the alignment optical system by using these compensated positions, and, the fine alignment of the substrate is performed by detecting these.

Here, as a method of fine alignment, apart from the die by die alignment method in which an alignment mark is detected in each of the shot regions upon the substrate, and alignment is performed with the pattern which is transcribed upon the substrate, there is an EGA (Enhanced Global Alignment) method. With this EGA method, the positions of alignment marks are detected which are respectively associated with at least 3 shot regions which are selected from a plurality of shot regions upon the substrate (these are termed the sample shot regions), and the position of each shot region upon the substrate is calculated statistically by an approximation calculation procedure, using the actual positions of the alignment shot regions and their design positions (or their compensated positions). By doing this, the substrate is shifted in order according to these positions which are calculated, and the respective patterns upon the mask for each of the subsequent layers are transcribed onto the plurality of shot regions in the state of being accurately positionally aligned. It should be understood that the measurement region of the alignment optical system is set as the center of the design position of the search mark during the search alignment procedure, and is set as the center of the design position or of the compensated position of the alignment mark during the fine alignment procedure. The alignment optical system detects the mark within the measurement region.

Although in, for example, the manufacture of a semiconductor device it may happen that the alignment marks are transcribed onto each layer as shifted, in this case, when an alignment mark which has been used for the previous layer (or for the previous to the previous layer) is visible through the layer above, then it may happen that a mark of the same type (a mark upon the previous layer) comes to be present in the vicinity of the alignment mark which is the subject of detection. When the alignment marks are present in the vicinity of one another, even if the system has guided the alignment mark which is the subject of detection in the measurement region of the alignment optical system based upon the accuracy of the pre-alignment, it may happen that a plurality of marks of the same kind undesirably enter into the measurement region, or that only a mark other than the subject of detection enters into the measurement region. In this case since, with a prior art alignment optical system, during the fine alignment, it is not decided whether any mark is the subject for detection, or whether a mark within the measurement region is the subject of detection, accordingly it may happen (undesirably) that the measurement of the position of an alignment shot region is performed based upon an erroneous alignment mark which is not the subject of detection, which will remarkably deteriorate the accuracy of alignment.

Furthermore, it also may happen that the alignment procedure is performed for a pattern of a subsequent layer by utilizing an alignment mark which was used for the previous layer (or the previous to the previous layer). In this case as well, it becomes difficult to specify the alignment mark for aligning the pattern from the subsequent layer from the large number of alignment marks which include the alignment marks for the previous layer (or the previous to the previous layer).

Yet further, with a sequence in which the search alignment is performed as in the prior art, it is necessary to prevent errors in detection of the search mark during the search alignment. In order for this, a forbidden zone is provided upon the substrate in order to prohibit formation of the same type of pattern (one resembling the search mark) at the vicinity of the search mark. This forbidden zone is provided in order to avoid the erroneous detection of a search mark, by ensuring that no other patterns enter into the measurement region when the search mark has been guided into the measurement region of the alignment optical system. However, the pattern transcription region upon the substrate is reduced in size by just the area of the forbidden zone, and the presence of a forbidden zone is not desirable from the point of view of efficient utilization of the substrate, because it imposes a restriction upon the ease of arrangement of the circuitry, and the like.

Furthermore, with a search mark upon a substrate, since the search mark which is provided upon the mask is transcribed onto the substrate and formed thereupon, each one of the search marks comes to be formed in each of the shot regions upon the substrate. However, since the number of search marks upon the substrate which are utilized in the search alignment procedure is 2 or 3, accordingly a large number of unused search marks which are not used in the search alignment procedure come to be formed upon the substrate. Since the mere existence of these search marks reduces the size of the pattern transcription region upon the substrate, this is not desirable from the point of view of efficient utilization of the substrate.

Even further, in the search alignment procedure, although two or more search marks which are separated upon the substrate are detected by the alignment optical system, when, after the alignment optical system detects the first search mark, it goes to detect the second search mark within the measurement region of the alignment optical system, if for example the substrate is deformed, since the actual relative position of the first search mark and the second search mark is different from the design relative position, the procedure of arranging the second search mark within the measurement region of the alignment optical system does not proceed smoothly.

Furthermore, although the image of the alignment mark which has been detected by the alignment optical system is image processed in the alignment procedure, the speed of processing is higher if the detection of the mark position is performed after compression processing of the image of the mark which has been obtained is performed, than if no such compression processing is performed. However, when compression processing is performed, if the mark is small, it may happen that it becomes impossible to perform detection of the position of the mark because the mark image is, undesirably, spoilt.

Still furthermore, when manufacturing a micro device, although a CMP (Chemical Mechanical Polishing) procedure may be performed in order to flatten the surface of the device, it sometimes happens that, due to the concave and convex state of the surface of the device, the surface of the device contacts the polishing surface of the CMP device at a certain inclination, which is undesirable, so that it may happen that the state of the polishing becomes uneven.

The present invention has been made in consideration of this type of circumstance, and it takes as its objective to provide a mark for position detection and a mark identification method, which, even when a large number of the same type of marks are present in the vicinity of a mark which is to be the subject of detection, can reliably detect this mark which is the subject of detection. Furthermore, it takes as its objective to provide an exposure method, which, by reliably detecting a mark which is the subject of detection, can enhance throughput by maintaining alignment accuracy even during a sequence in which fine alignment is performed, without performing any search alignment after pre-alignment, and which can perform-processing for exposure to light with good accuracy.

### SUMMARY OF THE INVENTION

In order to solve the above described problems, with the present invention, there are employed the structures below, which correspond to FIGS. 1 through 25 shown in the embodiments.

The mark (10) for position detection of the present invention is provided upon an object (P), and is used when detecting positional information of the object with a position detection device (9, CONT), and it comprises a first pattern (1) for outputting the positional information to the position detection device (9, CONT) by being observed by the position detection device (9, CONT); and a second pattern (2) which is arranged in a predetermined positional relationship with respect to the first pattern (1), and which consists of n patterns (where n=1) of N types (where N=2) combined, thus expressing Nn types of information.

The mark identification method of the present invention is a mark identification method for detecting positional information of an object (P) using a detection device (9, CONT), and for identifying a specific first mark (1A) from a plurality of first marks (1A through 1E) which are provided upon the object (P), and, upon the object (P), along with the first marks (1A through 1E), there is provided a second pattern (2) which is arranged in a predetermined positional relationship with respect to the first marks (1A through 1E), which consists of a combination of n patterns (where n=1) of N types (where N=2), and which expresses Nⁿ types of information; and the second pattern (2) is detected by the detection device (9, CONT), and the specific first mark (1A) is determined based upon information which is expressed by the second pattern (2).

In the position detection method of the present invention, by detecting a specific first mark (1A) which has been determined by a mark identification method as described above using the detection device (9, CONT), it detects the positional information for the object (P).

According to the present invention, by providing the second pattern which is associated in a predetermined positional relationship with respect to the first pattern for outputting positional information, by detecting the state of this second pattern, even if a mark of the same type is present in the vicinity of the mark which is to become the subject of detection, it is possible to specify the mark for use for position detection from this plurality of marks. Furthermore, since the second pattern is made up as a combination of n patterns of N types, even without setting the region for arrangement of the marks upon the substrate to be wide, it is possible to display information of the large number of Nⁿ types. The result of this is that, even though a large number of the same type of mark are present, it is possible to perform mark identification without squeezing down the pattern transcription region upon the substrate.

In the exposure method of the present invention is an exposure method which transcribes a prescribed pattern onto a substrate (P), upon the substrate (P), there are provided a first pattern (1) for detection of positional information by a position detection device (9, CONT), and: a second pattern (2) which is arranged in a predetermined positional relationship with respect to the first pattern (1), and which consists of n patterns (where n=1) of N types (where N=2) combined, thus expressing Nⁿ types of information; the second pattern (2) is detected by the detection device (9, CONT), and, based upon the information expressed by the second pattern (2), the positional information is detected from the first pattern (1); and, based upon the positional information which has been detected, the substrate (P) and the prescribed pattern are shifted relatively to one another, and the prescribed pattern is transcribed onto the substrate (P).

According to the present invention, since the second pattern is provided which is associated in the predetermined positional relationship with respect to the first pattern for outputting the positional information, by detecting the state of this second pattern, even if a plurality of patterns of the same type are present in the vicinity of the pattern which is to become the subject of detection, it is possible to specify the first pattern for use for position detection from this plurality of patterns, based upon the information expressed by the second pattern. Accordingly, it is possible to perform the alignment procedure with good accuracy using this first pattern, and it is possible to enhance the accuracy of the exposure to light. Furthermore, since the second pattern is made up as a combination of n patterns of N types, even without setting the region upon the substrate for arrangement of the first pattern for detecting the positional information to be wide, it is possible to display information of the large number of Nⁿ types. Accordingly, even though a pattern of the same type is present, along with being able to specify the first pattern for use for position detection, it is possible to perform the processing for exposure to light with good accuracy, without squeezing down the prescribed pattern transcription region upon the substrate.

The exposure method of the present invention is an exposure method which transcribes a prescribed pattern onto a substrate (P) in which, upon the substrate (P), there are provided a first pattern (1) and a second pattern (2) which is in a predetermined positional relationship with respect to the first pattern (1), and, among a plurality of marks (1, 10) formed upon the substrate (P): relative positional information for the first pattern (1) and the second pattern (2) of specified marks (1, 10) is detected; based upon the relative positional information, positional information for another mark (1′), among the plurality of marks (1) formed upon the substrate (P), which is different from the specified mark (1) is determined; and, based upon the positional information which has been determined, the substrate (P) and the prescribed pattern are shifted relatively to one another, and the prescribed pattern is transcribed onto the substrate (P).

According to the present invention, by detecting the relative positional information of the first pattern and the second pattern of the specified mark, it is possible, for example, to obtain information related to the amount of deformation of the substrate, or to its amount of rotation. And, even in a case such as when the relative position of the specified mark and another mark is different from their design relative position, it is possible to determine the positional information of the specified mark and of the other mark based upon the information which has been obtained. Accordingly, when detecting the other mark after having detected the specific mark within the measurement region of the position detection device, it is possible to perform shifting of the substrate smoothly, since the other mark is arranged in the measurement region of the position detection device.

The mark detection method of the present invention is a mark detection method which, using a mark detection device (9, CONT) of an image processing method which has a predetermined measurement region, detects a second mark (2) from upon an object (P) upon which are formed a first mark (1) and the second mark (2) which is in a predetermined positional relationship with respect to the first mark (1) and which is smaller than the first mark (1), and an image of the measurement region is photographed and image data is acquired; the image data is subjected to compression processing; positional information for the first mark (1) is detected from the image data which has been compression processed; and, based upon the positional information for the first mark (1) which has been detected, and relative positional information for the first mark (1) and the second mark (2), positional information for the second mark (2) is detected from the image data for the measurement region which have been photographed.

The exposure method of the present invention is an exposure method in which, using a mark detection device (9, CONT) of an image processing method which has a predetermined measurement region, a second mark (2) is detected from upon a substrate (P) upon which are formed a first mark (1) and the second mark (2) which is in a predetermined positional relationship with respect to the first mark (1) and which is smaller than the first mark (1), and, after having performed positional alignment of the mask (M) and the substrate (P), a pattern upon the mask (M) is exposed to light onto the substrate (P) such that an image of the measurement region is photographed and image data is acquired; the image data is subjected to compression processing; positional information for the first mark (1) is detected from the image data which has been compression processed; and, based upon the positional information for the first mark (1) which has been detected, and relative positional information for the first mark (1) and the second mark (2), positional information for the second mark (2) is detected from the image data for the measurement region which have been photographed.

According to the present invention, if for example the mark detection device is a detection device of an image processing method, then, although sometimes it happens that it is possible to enhance the processing speed by performing the mark detection after the image data has been compressed, it also sometimes happens that an inconvenience occurs, such as that the image of the second mark is blurred by the compression procedure, which is undesirable. However, by providing the first mark which is in a predetermined positional relationship with this second mark and moreover is larger than the second mark, the image data of this first mark is not blurred, even if compression processing is performed. Accordingly, the positional information of the first mark is detected by using the compressed image data for this first mark, and then it is possible to obtain the positional information for the second mark with good efficiency based upon the result of this detection.

The mark detection method of the present invention is mark detection method which detects marks (1, 2) upon an object using a mark detection device (9, CONT) which has a predetermined measurement region in which non subject marks (2) are provided at almost equal spacing in the vicinity of the subject mark (1) which is the subject of detection, and the subject mark (2) is detected.

The exposure method of the present invention is an exposure method in which marks (1, 2) upon a substrate (P) are detected using a mark detection device (9, CONT) which has a predetermined measurement region, and a pattern of a mask (M) is exposed to light onto the substrate (P) while positionally aligning the mask (M) and the substrate (P) in which non subject marks (2) are provided at almost equal spacing in the vicinity of the subject mark (1) which is the subject of detection, and the subject mark (1) is detected.

According to the present invention, by providing the non subject marks at almost equal spacing in the vicinity of the subject mark, it is possible to avoid, for example, the inconvenience that, when performing chemical mechanical polishing (CMP) of the device, the surface of the device should contact the polishing surface of the CMP device at an angle, and accordingly it is possible to perform the polishing procedure with good accuracy.

The positional information detection method of the present invention is a positional information detection method in which a subject mark (2) which is formed upon an object (P) is detected using a mark detection device (9, CONT) which detects the mark by a prescribed detection method, and, based upon this detection result, positional information for the object (P) is detected, and a non subject mark (1) which is formed upon the object (P) in a predetermined positional relationship with the subject mark (2), and of which the ease of detection by the predetermined detection method is high, is detected by the mark detection device (9, CONT); based upon the detection result of the non subject mark (1), and the predetermined positional relationship, the subject mark (2) is detected by the mark detection device (9, CONT); and, based upon the detection result for the subject mark (2), positional information for the object (P) is detected.

According to the present invention, when detecting the subject mark, by detecting the non subject mark which has a higher ease of detection and which moreover is in the predetermined positional relationship with respect to the subject mark, after having detected the non subject mark at a high processing speed, it is possible to perform detection of the subject mark with good efficiency, based upon the detection result for the non subject mark and the predetermined positional relationship.

The mark of the present invention is a mark which is formed upon an object, and which is used for detection of positional information of the object. The mark (P1, P2) is arranged in a desired position within a predetermined mark region (A1) which is ensured upon the object (P2), and information is expressed by its position within this mark region.

According to the present invention, since the information is expressed by the positional information of the mark, it becomes possible to express a larger amount of information, as compared to a case in which the information is expressed by the mere presence or absence of a mark.

Furthermore, the mark of the present invention is formed upon an object (P), and is used for detection of positional information for the object, and includes a first mark region (1) and a second mark region (A1) which is in a predetermined positional relationship with the first mark region; and wherein: a first mark is formed within the first mark region for detecting positional information for the object; a second mark (2, P1, P2) is formed within the second mark region and is arranged at a desired position within the second mark region; and information related to the first mark is expressed based upon the position of the second mark within the second mark region.

The exposure device of the present invention is an exposure device which comprises a detector (9) which detects positional information for a substrate by detecting a mark which is formed within a mark region which is made up of a first mark region and a second mark region upon the substrate (P), and a driver (CONT, PST, PSTD) which is electrically connected to the detector, and which shifts the prescribed pattern and the substrate relatively to one another, based upon positional information for the substrate which has been detected by the detector; and which transcribes the prescribed pattern onto a substrate, in which the mark which is detected by the detector comprises: a first mark (1) which, by being detected by the detector, generates a signal which expresses positional information for the substrate by the detector; and a second mark (2, P1, P2) which is arranged at a desired position within a second mark region; and the detector detects information related to the first mark based upon the position of the second mark within the second mark region (A1).

The exposure method of the present invention is an exposure method for transcribing a prescribed pattern onto a substrate (P), comprising: a process of detecting positional information for the substrate by detecting a mark (2) which is formed within a mark region which is made up of a first mark region (1) and a second mark region (A1) upon the substrate; and a process of, based upon positional information for the substrate which has been detected by the detector, shifting the prescribed pattern and the substrate relatively to one another and exposing the prescribed pattern to light; wherein: the mark (2) is a mark which comprises a first mark (1) which causes a position signal for the substrate to be generated by being detected by the detection process, and a second mark (2, P1, P2) which is formed in a desired position within the second mark region, and which expresses information which is related to the first mark by its position within the second mark region; and wherein: information which is related to the first mark is detected based upon the position of the second mark within the second mark region.

The method of manufacturing according to the present invention is a method of manufacturing an exposure device which exposes a prescribed pattern onto a substrate (P), wherein: there is provided a detector (9) which detects positional information for the substrate by detecting a mark which is formed in a mark region which consists of a first mark region (1) and a second mark region (A1) upon the substrate; there is also provided a driver (CONT, PST, PSTD) which shifts the substrate to a position in which the substrate is presented for exposure to light, based upon positional information for the substrate which has been detected by the detector; and wherein: the mark comprises: a first mark (1) which causes a signal which expresses positional information for the substrate to be generated by the detector, by being detected by the detector; and a second mark (2) which is arranged in a desired position within the second mark region; and wherein: the detector (9) detects information which is related to the first mark based upon the position of the second mark (2, P1, P2) within the second region (A1).

According to the present invention, since the information is expressed by the positional information of the mark, accordingly it becomes possible to express a greater amount of information, as compared with a case in which the information is expressed by the mere presence or the absence of a mark.

The mark of the present invention is a mark which is formed upon an object (P), and which is used for detection of positional information of the object, comprising: a vertical pattern portion (FIG. 23—P1) which extends in a first direction within a predetermined mark region which is ensured upon the object; and a horizontal pattern portion (FIG. 23—P2) which extends within the mark region in a second direction which intersects the first direction; and wherein: the information is expressed by the position of the intersection point between the vertical pattern portion and the horizontal pattern portion.

According to the present invention, since the information is expressed by the positional information of the mark, it is possible to express a greater amount of information, as compared with a case in which the information is expressed by the mere presence or absence of a mark. Furthermore since, because the vertical pattern portion extends along the first direction, it is possible to detect the position of the vertical pattern if it is possible to detect a portion anywhere upon the vertical pattern portion, and since, because the horizontal pattern portion extends along the second direction, it is possible to detect the position of the horizontal pattern if it is possible to detect a portion anywhere upon the horizontal pattern portion, and since, from these results, it is possible to obtain the position of the intersection point of the vertical pattern portion and the horizontal pattern portion, accordingly it becomes possible to be lax with the accuracy when relatively positioning the detection area of the detection device with respect to the pattern portion.

The mark of the present invention is a mark which is formed upon an object (P), and which is used for detection of positional information of the object, comprising: a first mark region (1) and a second mark region (A1) which is in a predetermined positional relationship with respect to the first mark region; and wherein: a first mark for detecting positional information for the object is formed within the first mark region; and a second mark (2) which is arranged in a desired position within the second mark region is formed within the second mark region; and the second mark comprises: a vertical pattern portion (FIG. 23—P1) which extends in a first direction within the second region; and a horizontal pattern portion (FIG. 23—P2) which extends within the second region in a second direction which intersects the first direction; and wherein: information related to the first pattern is expressed by the position of the intersection point between the vertical pattern portion and the horizontal pattern portion.

The exposure device of the present invention is an exposure device which comprises a detector (9) which detects positional information for a substrate by detecting a mark which is formed within a mark region which is made up of a first mark region (1) and a second mark region (A1) upon the substrate (P), and a driver (CONT, PST, PSTD) which is electrically connected to the detector, and which shifts the prescribed pattern and the substrate relatively to one another, based upon positional information for the substrate which has been detected by the detector; and which transcribes the prescribed pattern onto a substrate, wherein: the mark which is detected by the detector comprises: a first mark which, by being detected by the detector, generates a signal which expresses positional information for the substrate to the detector; and a second mark (2) which comprises a vertical pattern portion (FIG. 23—P1) which extends within the second region in a first direction, and a horizontal pattern portion (FIG. 23—P2) which extends within the second region in a second direction which intersects the first direction; and wherein: the detector detects information which is related to the first mark, based upon the position of the intersection point between the vertical pattern portion and the horizontal pattern portion of the second mark.

The exposure method of the present invention is an exposure method for transcribing a prescribed pattern onto a substrate (P), comprising: a process of detecting positional information for the substrate by detecting a mark which is formed within a mark region which is made up of a first mark region (1) and a second mark region (A1) upon the substrate; and a process of shifting the prescribed pattern and the substrate relatively to one another, based upon positional information for the substrate which has been detected by the detector, and exposing the prescribed pattern to light; wherein the mark comprises: a first mark which, by being detected by the detection process, generates a position signal for the substrate; and a second mark (2) which comprises a vertical pattern portion (FIG. 23—P1) which extends within the second region in a first direction, and a horizontal pattern portion (FIG. 23—P2) which extends within the second region in a second direction which intersects the first direction; and wherein: information which is related to the first mark is detected, based upon the position of the intersection point between the vertical pattern portion and the horizontal pattern portion.

The method of manufacturing of the present invention is a method of manufacturing an exposure device which exposes a prescribed pattern onto a substrate (P) in which there is provided a detector (9) which detects positional information for the substrate by detecting a mark which is formed in a mark region which consists of a first mark region (1) and a second mark region (A1) upon the substrate; there is also provided a driver (CONT, PST, PSTD) which shifts the substrate to a position in which the substrate is presented for exposure to light, based upon positional information for the substrate which has been detected by the detector; and wherein: the mark is a mark which comprises: a first mark which causes a signal which expresses positional information for the substrate to be generated by the detector, by being detected by the detector; and a second mark (2) which comprises a vertical pattern portion (P1) which extends within the second region in a first direction; and a horizontal pattern portion (P2) which extends within the second region in a second direction which intersects the first direction; and wherein: the detector detects information which is related to the first pattern, based upon the position of the intersection point between the vertical pattern portion and the horizontal pattern portion.

According to the present invention, since the information is expressed by the positional information of the mark, it becomes possible to express a greater quantity of information, as compared with the case of expressing the information by the mere presence or absence of a mark. Furthermore since, because the vertical pattern portion extends along the first direction, it is possible to detect the position of the vertical pattern if it is possible to detect a portion anywhere upon the vertical pattern portion, and since, because the horizontal pattern portion extends along the second direction, it is possible to detect the position of the horizontal pattern if it is possible to detect a portion anywhere upon the horizontal pattern portion, and since it is possible to obtain the position of the intersection point of the vertical pattern portion and the horizontal pattern portion, accordingly it becomes possible to be lax with the accuracy when relatively positioning the detection area of the detection device with respect to the pattern portion.

The mark of the present invention is a mark which is formed upon an object, and which is used for detection of positional information for the object comprises a pattern portion which extends within the mark region in a first direction; and wherein: the information is expressed based upon a position which is related to the second direction of the intersection in the first direction of the pattern portion within the mark region.

According to the present invention, since the information is expressed by the positional information of the mark, it becomes possible to express a greater quantity of information, as compared with the case of expressing the information by the mere presence or absence of a mark. Furthermore since, because the pattern portion extends along the first direction, it is possible to detect the position of the pattern if it is possible to detect a portion anywhere upon the pattern portion, accordingly it becomes possible to be lax with the accuracy when relatively positioning the detection area of the detection device with respect to the pattern portion. Yet further, it is possible to simplify the detection process, since it will be acceptable to detect the position of the pattern portion only in relation to the second direction, in other words, only in relation to a single direction.

The mark of the present invention is a mark which is formed upon an object (P), and which is used for detection of positional information for the object: comprising a first mark region (1) and a second mark region (A1) which is in a predetermined positional relationship with respect to the first mark region; and comprising: a first mark which is formed within the first mark region, and which is used for detecting positional information for the object; and a second mark which comprises a pattern portion (FIG. 24—P1) which extends in a first direction within the second region, and which expresses information which is related to the first mark according to the position related to the second direction of the pattern portion within the second region which intersects in the first direction.

The exposure device of the present invention is an exposure device which comprises a detector (9) which detects positional information for a substrate by detecting a mark which is formed within a mark region which is made up of a first mark region (1) and a second mark region (A1) upon the substrate (P), and a driver (CONT, PST, PSTD) which is electrically connected to the detector, and which shifts the prescribed pattern and the substrate relatively to one another, based upon positional information for the substrate which has been detected by the detector; and which transcribes the prescribed pattern onto a substrate, wherein: the mark which is detected by the detector comprises: a first mark which is formed in the first mark region, and which, by being detected by the detector, generates a signal which expresses positional information for the substrate by the detector; and a second mark (2) which comprises a pattern portion (FIG. 24—P1) which extends in a first direction within the second region (FIG. 24—A1); and the detector detects information related to the first mark, based upon the position related to the second direction of the pattern portion of the second mark within the second region.

The exposure method of the present invention is an exposure method for transcribing a prescribed pattern onto a substrate (P), comprising: a process of detecting positional information for the substrate by detecting a mark which is formed within a mark region which is made up of a first mark region (1) and a second mark region (A1) upon the substrate; and a process of shifting the prescribed pattern and the substrate relatively to one another, based upon positional information for the substrate which has been detected, and exposing the prescribed pattern to light; wherein the mark comprises: a first mark which, by being detected by the detection process, generates a position signal for the substrate; and a second mark (2) which comprises a pattern portion (FIG. 25—P1) which extends in a first direction within the second region (A1); wherein, by the process of detecting the positional information, information related to the first mark is detected, based upon a position which is related to the second direction of the intersection in the first direction of the pattern portion within the second region.

The method of manufacturing of the present invention is a method of manufacturing an exposure device which exposes a prescribed pattern onto a substrate (P), wherein: there are provided a detector (9) which detects positional information for the substrate by detecting a mark which is formed in a mark region which consists of a first mark region (1) and a second mark region (A1) upon the substrate, and a driver which shifts the substrate to a position in which the substrate is presented for exposure to light, based upon positional information for the substrate which has been detected by the detector; and wherein: the mark comprises: a first mark which causes a signal which expresses positional information for the substrate to be generated by the detector, by being detected by the detector; and a second mark (2) which comprises a pattern portion (FIG. 24—P1) which extends in a first direction within the second region, and the detector expresses information related to the first mark based upon a position which is related to the second direction of the intersection in the first direction of the pattern portion within the second region; wherein the detector detects information which is related to the first mark based upon the position of the pattern portion within the second region.

According to the present invention, since the information is expressed by the positional information of the mark, it becomes possible to express a greater quantity of information, as compared with the case of expressing the information by the mere presence or absence of a mark. Furthermore since, because the pattern portion extends along the first direction, it is possible to detect the position of the pattern if it is possible to detect a portion anywhere upon the pattern portion, accordingly it becomes possible to be lax with the accuracy when relatively positioning the detection area of the detection device with respect to the pattern portion. Yet further, since it will be sufficient to detect the position of the pattern portion only with respect to the second direction, in other words, only with respect to one direction, accordingly it is possible to enhance the simplicity of the detection process.

As in the above, according to the present invention, by providing the second pattern as a combination of n examples of N types of pattern in a predetermined positional relationship with respect to the first pattern for outputting the positional information, and by detecting the shape of this second pattern, even if the same type of marks are present adjacent to the mark which is to be the subject of detection, it is possible to specify the mark which is to be used for position detection from this plurality of marks. And it is possible for the second pattern to display Nⁿ types of information, i.e. a large number, even though the region for arranging the marks upon the substrate is not set to be particularly wide, and, even if a large number of the first patterns of the same type are present, it is possible to perform the mark identification procedure without squeezing down the pattern transcription region upon the substrate. And it is possible to perform the alignment procedure at good accuracy by utilizing this first pattern.

Furthermore, according to the present invention, by detecting the relative positional information of a first pattern and a second pattern of a specified mark, it is possible to obtain information related to the amount of deformation and the amount of rotation of the substrate. Accordingly it is possible, based upon this information which has been obtained, to determine the positions of other marks from the specified mark, and, since it is possible to perform detection of these plurality of marks smoothly, it is possible to enhance throughput.

Furthermore, according to the present invention, when performing mark detection from image data of a mark which are compressed, since the image data of a large non subject mark cannot be squeezed down even if they are subjected to compression processing, accordingly it is possible to detect the positional information of the non subject mark using the compressed image data of this non subject mark, and to obtain the positional information of the subject mark quickly based upon this detection result. Accordingly, it is possible to perform the mark position detection procedure in a short period of time with good efficiency.

Furthermore, according to the present invention, by providing non subject marks at equal spacing around the vicinity of the subject mark, it is possible to avoid the inconvenience that the surface of the device may contact at an inclination with respect to the polishing surface of a CMP device, so that it is possible to perform a polishing procedure with good accuracy. Accordingly, it is possible to manufacture a device which is endowed with the desired functionality.

In the present invention, the mark which is formed on an object and provided with a subsidiary pattern comprises a mark for position detection which detects a position, the subsidiary pattern which is used for identify the mark for position detection which is a target on the object on which a plurality of marks for position detection are formed.

In the present invention, the mark for position detection which is provided with the subsidiary pattern of claim 100, a subsidiary pattern forming area in which the subsidiary pattern is allowed to be formed in a predetermined positional relationship with the mark for position detection, wherein the subsidiary pattern shows an information which identifies the mark for position detection as a target according to whether or not the subsidiary pattern is formed in the subsidiary pattern forming area.

In the present invention, a mark for position detection which is provided with the subsidiary pattern of claim 100 such that the subsidiary pattern shows an information which identifies an identification mark as a target according to a shape of the subsidiary pattern.

In an exposure method of the present invention, the mark for position detection as a target is identified by using the subsidiary pattern from above the object on which the mark for position detection which is provided with the subsidiary pattern of claim 100 is formed, a relational position between a device pattern which is projected on the object and the object is controlled according to a positional information of the object which is obtained as a result of a measurement for the mark for position detection as a target, and a device pattern is transcribed on the object of which relational position is controlled.

In an exposure method according to the present invention, the subsidiary pattern has a predetermined positional relationship which is defined for the mark for position detection, the mark for position detection is measured in a step which identifies the mark for position detection, and after that, an information which identifies the mark for position detection as a target is detected from the identified pattern by using a relational positional information of the subsidiary pattern with reference to the mark for position detection.

In an exposure method according to the present invention, the mark for position detection which is provided with the subsidiary pattern has a predetermined positional relationship with the mark for position detection and is provided with the subsidiary pattern forming area in which the subsidiary pattern is allowed to be formed, and the subsidiary pattern shows an information which identifies the mark for position detection as a target according to whether or not the subsidiary pattern is formed in the subsidiary pattern forming area.

In the present invention, an exposure device which transcribes the device pattern on the object of which relative position is controlled comprises a detection device which detects the mark for position detection from above the object on which the mark for position detection which is provided with the subsidiary pattern of claim 1 is formed, an identification device which identifies the mark for position detection as a target by using the subsidiary pattern, an projection optical system which projects an image of a device pattern on the object, and a position control device which controls the relative position between the image of the device pattern which is projected on the object and the object according to the position information of the object which is obtained as a result of a measurement for the mark for position detection as a target.

In the present invention, a device manufacturing method comprises the steps of identifying the mark for position detection as a target by using the subsidiary pattern from above the object on which the mark for position detection which is provided with the subsidiary pattern of claim 100 is formed, controlling the relative position between the image of the device pattern which is projected on the object and the object according to the position information of the object which is obtained as a result of a measurement for the mark for position detection as a target, and transcribing the device pattern on the object of which relative position is controlled.

In an exposure method according to the present invention, the mark for position detection which is provided with the subsidiary pattern has a predetermined positional relationship with reference to the mark for position detection and is provided with a subsidiary pattern forming area in which the subsidiary pattern is allowed to be formed, and the subsidiary pattern shows an information which identifies the mark for position detection as a target according to whether or not the subsidiary pattern is formed in the subsidiary pattern forming area.

A device of the present invention is manufactured by using the device manufacturing method of the present invention.

In the mark for position detection of the present invention which is provided with the subsidiary pattern of claim 100, the mark for position detection is provided with a plurality of pattern sections which extend to a predetermined direction and are formed periodically, the subsidiary pattern is formed in a part of the pattern section among a plurality of the pattern sections continuously, and the mark for position detection as a target is identified by differentiating a shape of a part of the pattern section among a plurality of the pattern sections from a shape of the other pattern sections among a plurality of the pattern sections.

In the present invention, an exposure method comprises the steps of forming a plurality of marks for position detection according to a positional arrangement such that a positional relationship of a plurality of marks for position detection form a predetermined arrangement, detecting the predetermined arrangement from above the object, specifying the mark for position detection as a target among the marks for position detection which form the predetermined arrangement according to an information for the predetermined arrangement, obtaining an information for the position of the object by using the specified information for the position for the mark for position detection as a target, controlling the relative position between the image of the device pattern which is projected on the object and the object according to the information for the position of the object, and transcribing the device pattern on the object of which relative position is controlled.

### BRIEF DESCRIPTION OF THE DRAWINGS

FIG. 1 is a schematic structural view showing an embodiment of the exposure device according to the present invention.

FIG. 2 is a figure showing a first embodiment of the mark for position detection of the present invention.

FIG. 3A is a figure showing an example of the mark for position detection according to the first embodiment of the present invention.

FIG. 3B is a figure showing an example of the mark for position detection according to the first embodiment of the present invention.

FIG. 3C is a figure showing an example of the mark for position detection according to the first embodiment of the present invention.

FIG. 3D is a figure showing an example of the mark for position detection according to the first embodiment of the present invention.

FIG. 3E is a figure showing an example of the mark for position detection according to the first embodiment of the present invention.

FIG. 3F is a figure showing an example of the mark for position detection according to the first embodiment of the present invention.

FIG. 4A is a figure showing the situation when a mark for position detection is detected using this position detection device.

FIG. 4B is a figure showing an example of a photographic signal which has been outputted by a photographic element for the X axis.

FIG. 4C is a figure showing an example of a photographic signal which has been outputted by a photographic element for the Y axis.

FIG. 5 is a flow chart for explanation of a summary of the alignment procedure.

FIG. 6 is a figure showing a plurality of marks for position detection which are disposed within a measurement region of a position detection device.

FIG. 7 is a flow chart showing a first embodiment of the mark identification method of the present invention.

FIG. 8 is a figure for explanation of the first embodiment of the mark identification method of the present invention.

FIG. 9 is a figure for explanation of the first embodiment of the mark identification method of the present invention.

FIG. 10 is a figure showing another embodiment of the mark for position detection of the present invention.

FIG. 11A is a figure showing a second embodiment of the mark for position detection and the mark identification method of the present invention.

FIG. 11B is a figure showing the second embodiment of the mark for position detection and the mark identification method of the present invention.

FIG. 11C is a figure showing the second embodiment of the mark for position detection and the mark identification method of the present invention.

FIG. 11D is a figure showing the second embodiment of the mark for position detection and the mark identification method of the present invention.

FIG. 11E is a figure showing the second embodiment of the mark for position detection and the mark identification method of the present invention.

FIG. 11F is a figure showing the second embodiment of the mark for position detection and the mark identification method of the present invention.

FIG. 11G is a figure showing the second embodiment of the mark for position detection and the mark identification method of the present invention.

FIG. 11H is a figure showing the second embodiment of the mark for position detection and the mark identification method of the present invention.

FIG. 11I is a figure showing the second embodiment of the mark for position detection and the mark identification method of the present invention.

FIG. 11J is a figure showing the second embodiment of the mark for position detection and the mark identification method of the present invention.

FIG. 11K is a figure showing the second embodiment of the mark for position detection and the mark identification method of the present invention.

FIG. 11L is a figure showing the second embodiment of the mark for position detection and the mark identification method of the present invention.

FIG. 12 is a figure showing a third embodiment of the mark for position detection and the mark identification method of the present invention.

FIG. 13A is a figure for explanation of the operation of the third embodiment of the mark for position detection of the present invention.

FIG. 13B is a figure for explanation of the operation of the third embodiment of the mark for position detection of the present invention.

FIG. 13C is a figure for explanation of the operation of the third embodiment of the mark for position detection of the present invention.

FIG. 13D is a figure for explanation of the operation of the third embodiment of the mark for position detection of the present invention.

FIG. 13E is a figure for explanation of the operation of the third embodiment of the mark for position detection of the present invention.

FIG. 14A is a figure showing a fourth embodiment of the mark for position detection and the mark identification method of the present invention.

FIG. 14B is a figure showing the fourth embodiment of the mark for position detection and the mark identification method of the present invention.

FIG. 14C is a figure showing the fourth embodiment of the mark for position detection and the mark identification method of the present invention.

FIG. 15A is a figure showing another example of the fourth embodiment of the mark for position detection and the mark identification method of the present invention.

FIG. 15B is a figure showing another example of the fourth embodiment of the mark for position detection and the mark identification method of the present invention.

FIG. 16 is a figure showing a fifth embodiment of the mark for position detection and the mark identification method of the present invention.

FIG. 17 is a figure for explanation of a sixth embodiment of the mark identification method of the present invention.

FIG. 18 is a flow chart for explanation of a seventh embodiment of the mark identification method of the present invention.

FIG. 19A is a figure for explanation of the seventh embodiment of the mark identification method of the present invention.

FIG. 19B is a figure for explanation of the seventh embodiment of the mark identification method of the present invention.

FIG. 20A is a figure for explanation of an eighth embodiment of the mark identification method of the present invention.

FIG. 20B is a figure for explanation of the eighth embodiment of the mark identification method of the present invention.

FIG. 20C is a figure for explanation of the eighth embodiment of the mark identification method of the present invention.

FIG. 20D is a figure for explanation of the eighth embodiment of the mark identification method of the present invention.

FIG. 21 is a figure showing a ninth embodiment of the mark for position detection of the present invention.

FIG. 22A is a figure for explanation of the operation of the ninth embodiment of the mark for position detection of the present invention.

FIG. 22B is a figure for explanation of the operation of the ninth embodiment of the mark for position detection of the present invention.

FIG. 23A is a figure for explanation of the operation of a tenth embodiment of the mark identification method of the present invention.

FIG. 23B is a figure for explanation of the operation of the tenth embodiment of the mark identification method of the present invention.

FIG. 23C is a figure for explanation of the operation of the tenth embodiment of the mark identification method of the present invention.

FIG. 23D is a figure for explanation of the operation of the tenth embodiment of the mark identification method of the present invention.

FIG. 23E is a figure for explanation of the operation of the tenth embodiment of the mark identification method of the present invention.

FIG. 24 is a figure for explanation of an example of application of the tenth embodiment of the present invention.

FIG. 25A is a figure for explanation of an eleventh embodiment of the mark identification method of the present invention.

FIG. 25B is a figure for explanation of the eleventh embodiment of the mark identification method of the present invention.

FIG. 25C is a figure for explanation of the eleventh embodiment of the mark identification method of the present invention.

FIG. 25D is a figure for explanation of the eleventh embodiment of the mark identification method of the present invention.

FIG. 26 is a flow chart showing an example of a semiconductor device manufacturing process.

### DETAILED DESCRIPTION OF THE INVENTION

First Embodiment

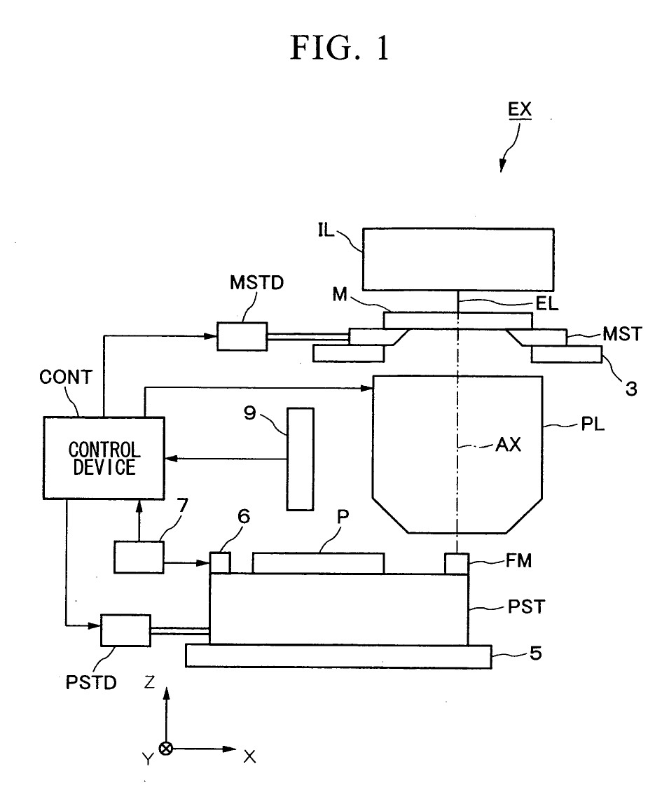

In the following, first embodiments of the mark identification method and the exposure method according to the first embodiment of the present invention will be explained with reference to the figures. This embodiment is one which employs the mark identification method of the present invention in an alignment process (a so called scanning step) of an exposure device which exposes to light a pattern on a mask onto a photosensitive substrate by the step-and-scan method; and FIG. 1 is a schematic structural view of this exposure device. It should be understood that here “photosensitive substrate” includes a resist which has been applied upon a semiconductor wafer, and “mask” includes a reticle upon which there is formed a device pattern which is reduction projected upon a photosensitive substrate.

In FIG. 1, an exposure device EX comprises a mask stage MST which supports a mask M, a substrate stage PST which supports a photosensitive substrate P, an illumination optical system IL which illuminates the mask M which is supported upon the mask stage MST with exposure light EL, and a projection optical system PL which performs exposure to light by projecting a pattern on the mask M which is illuminated with the exposure light EL upon the photosensitive substrate P which is supported upon the substrate stage PST. In this embodiment, the exposure device EX is a so called scanning stepper. Furthermore, in the following explanation, the direction which agrees with the optical axis AX of the projection optical system PL will be taken as the Z axis direction, the simultaneous shifting direction of the mask M and the photosensitive substrate P in the plane orthogonal to the Z axis direction will be taken as the X axis direction, and the direction which is orthogonal to the Z axis direction and the X axis direction will be taken as the Y axis direction.

The illumination optical system IL is a device which illuminates a mask M which is supported upon the mask stage MST with the exposure light EL, and it comprises a light source, an optical integrator which makes uniform the intensity of the luminous flux which has been emitted from the light source, a condenser lens which collects the exposure light EL from the optical integrator, a relay lens system, a variable field window which sets the illuminated region upon the mask M to a slit shape, and the like. As the exposure light EL which is emitted from the illumination optical system IL, there may be used, for example, an emission line in the ultraviolet region which is emitted from a mercury lamp (the g line, the h line, the i line), and far ultraviolet light (DUV light) such as KrF excimer laser light (of wavelength 248 nm) or the like, or vacuum ultraviolet light (VUV) such as ArF excimer laser light (of wavelength 193 nm) and F2 laser light (of wavelength 157 nm) or the like.

The mask stage MST is a device which supports the mask M, and can be shifted with respect to the base 3 in two dimensions in a plane which is perpendicular to the optical axis AX of the projection optical system PL, in other words in the X-Y plane, and can also be finely rotated. This mask stage MST is driven by a drive device MSTD such as a linear motor or the like, and this drive device MSTD is controlled by a control device CONT which controls the operation of the entire exposure device in an integrated manner.

The projection optical system PL consists of a plurality op optical elements (lenses), and these optical elements are supported upon a lens barrel. In this embodiment, the projection optical system PL is a reduction system whose projection ratio is, for example, 1/4 or 1/5. It should be understood that this projection optical system PL may also be either a equal ratio system or a magnification system. Furthermore, the projection optical system PL comprises an imaging characteristic control device not shown in the drawings which performs compensation of the optical characteristics. This imaging characteristic control device performs compensation of the optical characteristic of the projection optical system PL, such as its projection ratio, its distortion aberration, or the like, by, for example, performing spacing adjustment of a part of the lens group which makes up the projection optical system PL, or by performing gas pressure adjustment within a lens chamber of a part of the lens group. This imaging characteristic control device is controlled by the control device CONT.

The substrate stage PST is a device which supports the photosensitive substrate P, and comprises: an XY stage which determines the position of the photosensitive substrate P upon a stand 5 two dimensionally in a plane which is perpendicular to the optical axis AX of the projection optical system PL, in other words in the XY plane; a Z stage which determines the position of the photosensitive substrate P in the direction which is parallel to the optical axis AX of the projection optical system PL, in other words in the Z axis direction; and a θ stage which finely rotates the photosensitive substrate P.

A shift mirror 6 is provided upon the substrate stage PST. Furthermore, a laser interferometer 7 is provided in a position which confronts this shift mirror 6. The shift mirror 6 consists of a plane mirror which has a vertical reflection plane in the X axis and a plane mirror (not shown in the drawing) which has a vertical reflection plane in the Y axis. The laser interferometer 7 consists of a laser interferometer for the X axis which illuminates a laser beam upon the shift mirror 6 along the X axis and a laser interferometer for the Y axis (not shown in the drawing) which illuminates a laser beam upon the shift mirror along the Y axis, and the position (the X coordinate and the Y coordinate) in the X direction and in the Y direction of the substrate stage PST is measured by these laser interferometers 7 for the X axis and for the Y axis. Furthermore, the rotational angle of the substrate stage PST is measured from the difference between two measurement values by arranging two of the laser interferometers 7 in parallel along one of the X axis and the Y axis. The measurement results for the positional information of the substrate stage PST due to these laser interferometers 7, such as its X coordinate, its Y coordinate, its rotational angle and so on, are outputted to the control device CONT, and the control device CONT controls the position determination operation of the substrate stage PST via the drive device PSTD such as a linear motor or the like while monitoring this positional information. Although this matter is not shown in FIG. 1, it should be understood that, in the same manner, a system comprising a plurality of laser interferometers is also included in the mask stage MST, and measures the positional information of the mask stage MST (of the mask M) such as its X coordinate, its Y coordinate, its rotational angle and so on. These measurement results are outputted to the control device CONT.

The exposure device EX comprises an alignment optical system (a position detection device or mark detection device) 9 which is disposed separately from the projection optical system PL, and which utilizes an off-axis method. This alignment optical system 9 is provided with a rectangular shaped measurement region, and irradiates broadband light of wavelength about 550˜750 nm which is emitted by, for example, a halogen lamp upon alignment marks (marks for position detection) which are provided upon the photosensitive substrate P, and detects an image of indicator marks which are arranged upon a surface which is conjugate to the surface of the photosensitive substrate and an image of the alignment marks which are present within the measurement region with a photographic element (a CCD). The control device CONT, after aligning the image of the pattern upon the mask M and a shot region upon the photosensitive substrate P using the alignment optical system 9, along with scanning the mask stage MST in a direction which is perpendicular to the optical axis AX of the projection optical system PL (in this embodiment, the +X direction), synchronously with this, scans the substrate stage PST in, for example, the opposite direction (the −X direction) at a speed ratio which is the same as the projection magnification of the projection optical system PL, and sequentially transcribes (exposes to light) the pattern image upon the mask M to each of the shot regions upon the photosensitive substrate P.

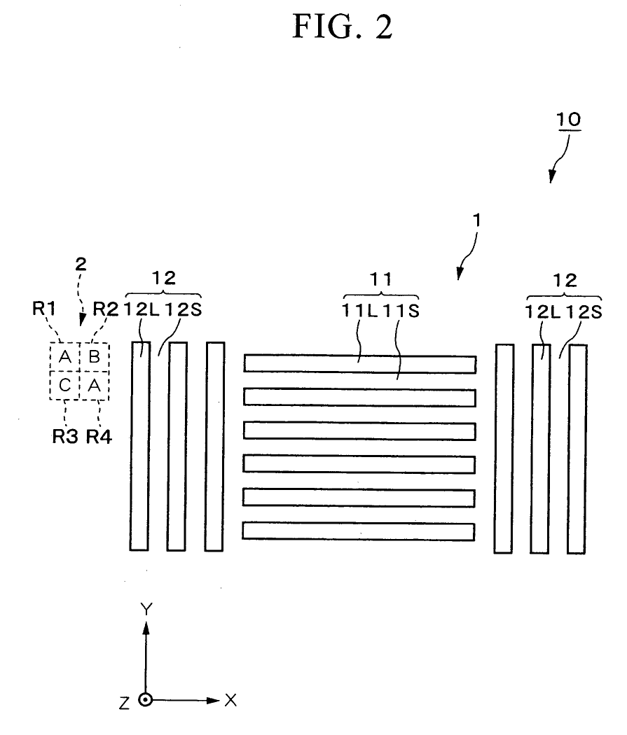

Next, while referring to FIG. 2, the alignment marks which are provided upon the photosensitive substrate P will be explained. FIG. 2 is a figure showing a mark for position detection 10 which includes an alignment mark 1 provided upon the photosensitive substrate P.

As shown in FIG. 2, the mark for position detection 10 is provided upon the photosensitive substrate P, and is a mark which is used when detecting the positional information within the XY plane of the photosensitive substrate P by the alignment detection system 9; and it comprises an alignment mark (a first pattern or first mark) 1 for outputting positional information to the alignment optical system 9 by being observed by the alignment optical system 9, and a identification mark (a second pattern or second mark) 2 which is arranged in a predetermined positional relationship with the alignment mark 1. In the figure, the alignment mark 1 comprises a mark 11 for Y detection in which pattern portions 11L and space portions 11S which extend over a prescribed length in the X axis direction are arranged periodically in the Y axis direction, and marks 12 for X detection, which are provided on both X axis direction sides of the mark 11 for Y detection, and in which pattern portions 12L and space portions 12S which extend over a prescribed length in the Y axis direction are arranged periodically in the X axis direction. In this embodiment, all of the plurality of pattern portions 11L are of the same length, and each of the plurality of space portions 11S has the same size (spacing) in the Y axis direction. In the same manner, the plurality of pattern portions 12L are also of the same length, and each of the plurality of space portions 12S also has the same size (spacing) in the X axis direction.

The identification mark 2 is a mark for identifying, among the plurality of alignment marks 1 which are provided upon the photosensitive substrate P, that alignment mark 1 which should be used in the alignment procedure, and is provided in association with each of the plurality of alignment marks 1. The identification mark shown in FIG. 2 is made up by arranging a character pattern of three types A, B, and C in each of four regions R1 through R4 which are arranged in a predetermined positional relationship with the alignment mark 1. The regions R1 through R4 are provided in prescribed positions (relative positions) which are set in advance with respect to the alignment mark 1, and the region R1 and the region R2 are provided in order along the X axis direction and the region R3 and the region R4 are provided in order along the X axis direction, while the region R1 and the region R3 are provided in order along the Y axis direction and the region R2 and the region R4 are provided in order along the Y axis direction. One of the three types of character pattern A, B, and C is disposed in the region R1, one of the three types of character pattern A, B, and C is disposed in the region R2, one of the three types of character pattern A, B, and C is disposed in the region R3, and one of the three types of character pattern A, B, and C is disposed in the region R4. Here, the character patterns A, B, and C which are disposed in each of the regions R1 through R4 are determined according to the associated alignment mark 1. And, by arranging the three types of character pattern in each of the four regions, the identification mark 2 can provide information of 3⁴ types.

Here, with the identification mark 2 shown in FIG. 2, the number of the regions R1 through R4 is four, and the number of character patterns A through C is three, but, provided that the number of regions n and the number of character patterns N are natural numbers greater than or equal to 2, by arranging the N types of character pattern in each of the n regions which are arranged in the predetermined positional relationship with the alignment mark 1, the identification mark 2 can provide information of Nⁿ types. Furthermore, it would also be acceptable to make the number of regions n equal to 1, and then to select and dispose any one from among a plurality of character patterns in that one region.

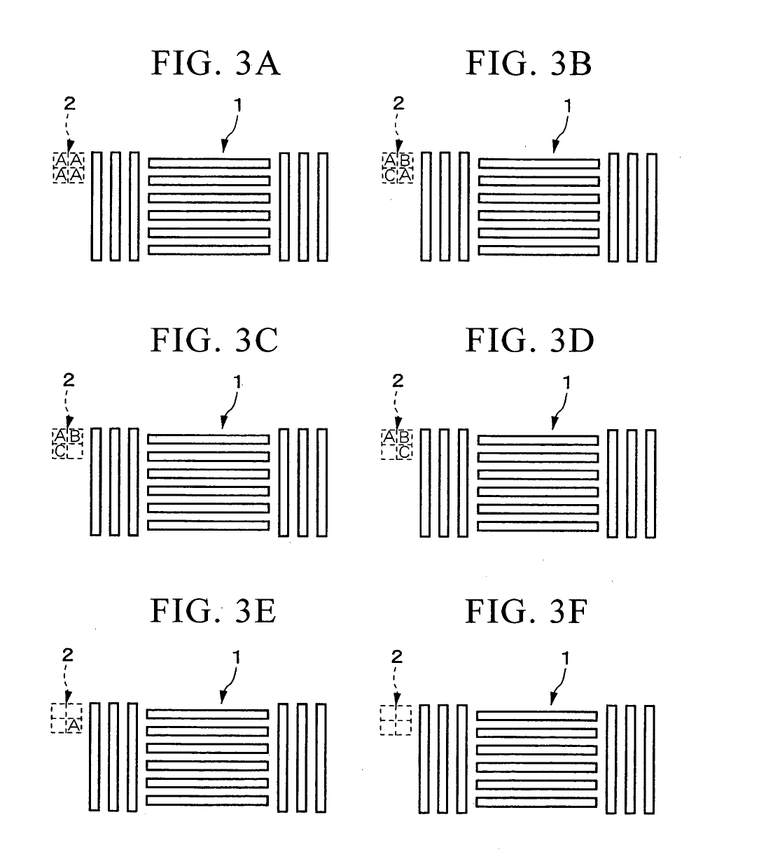

FIGS. 3A through 3F are figures showing examples of the structure of the identification mark 2.

With the identification mark 2 shown in FIG. 3A, the character pattern A is provided in each one of the regions R1 through R4. With the identification mark 2 shown in FIG. 3B, the character pattern A is provided in the region R1, the character pattern B is provided in the region R2, the character pattern C is provided in the region R3, and the character pattern A is provided in the region R4. With the identification mark 2 shown in FIG. 3C, the character pattern A is provided in the region R1, the character pattern B is provided in the region R2, the character pattern C is provided in the region R3, and no character pattern is provided in the region R4. In this manner, it is possible to define the case in which no character pattern is provided in one among the four (the n) regions R1 through R4 as being one type. Here, the structure is such that a character pattern is provided in each of the regions R1 through R3, while only in the region R4 is no character provided; but the region in which no character pattern is provided may be any of the regions R1 through R4. In other words, as with the identification mark 2 shown in FIG. 3D, it is also acceptable for the structure to be such that no character pattern is provided in the region R3, while the character patterns A, B, and C are provided in the regions R1, R2, and R4 respectively. Here, the identification mark of FIG. 3C and the identification mark 2 of FIG. 3D can be identified as being marks of different types. With the identification mark 2 shown in FIG. 3E, there are no character patterns in the regions R1 through R3, while the character pattern A is provided in the region R4. In this manner, it is possible to form a structure in which a character pattern is provided in only one of the four (the n) regions R1 through R4 which are present. Here, the identification mark of FIG. 3E and, for example, the identification mark 2 of FIG. 3A can be identified as being marks of different types. With the identification mark 2 shown in FIG. 3F, no character pattern is present in any of the regions R1 through R4. In this manner, it is possible to form a structure in which no character pattern is present in any of the four (the n) regions R1 through R4 which are present. Here, the identification mark of FIG. 3F and, for example, the identification mark 2 of FIG. 3A can be identified as being marks of different types.

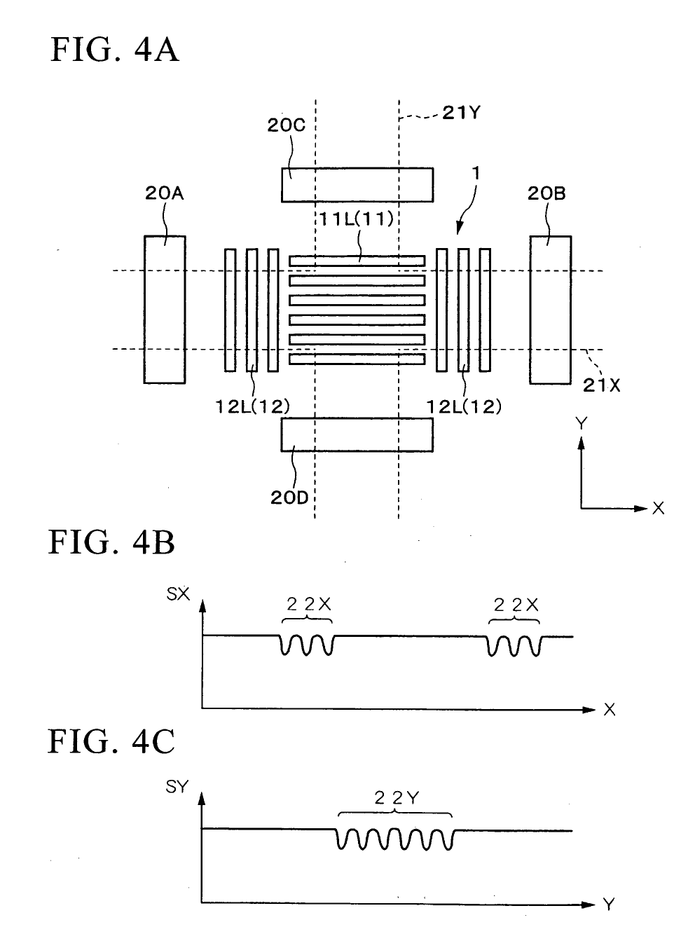

FIG. 4A shows a situation in which an image of the alignment mark 1 upon the photosensitive substrate P has been imaged by the alignment optical system 9 upon an indicator plate (not shown in the drawing) which has an indicator mark 20 (20A through 20D). Here, the alignment mark is illuminated with detection light for alignment, and the indicator mark 20 is illuminated with illumination light which is independent from the detection light for alignment. The image of the alignment mark 1 comprises an image of the mark 11 for Y detection which has the pattern portion 11L which extends in the prescribed direction (the X axis direction), and an image of the mark 12 for X detection which has the pattern portion 12L which extends in the direction (the Y axis direction) which is orthogonal to the prescribed direction; and each of their directions of extension is conjugate to the X axis direction and the Y axis direction of the stage coordinate system. And two indicator marks 20A and 20B are formed upon the indicator plate so as to sandwich the image of the alignment mark 1 in the X axis direction, and furthermore two indicator marks 20C and 20D are formed upon the indicator plate so as to sandwich the image of the alignment mark 1 in the Y axis direction, and these indicator marks 20A through 20D are arranged to be conjugate to the surface of the photosensitive substrate P. Furthermore, in the alignment optical system 9, there are provided a photographic element for the X axis which performs scanning in a direction which corresponds to the X axis direction, and a photographic element for the Y axis which performs scanning in a direction which corresponds to the Y axis direction. The photographic element for the X axis performs photography of the image within a detection region 21X for the X axis direction by scanning the indicator marks 20A and 20B and the pattern portion 12L in the transverse direction. On the other hand, the photographic element for the Y axis performs photography of the image within a detection region 21Y for the Y axis direction by scanning the indicator marks 20C and 20D and the pattern portion 11L in the transverse direction. And the photographic element for the X axis outputs the photographic signal SX (luminance data) shown in FIG. 4B. In FIG. 4B, a signal section 22X corresponds to the pattern portion 12L of the mark 12 for X detection, and, by this photographic signal SX being analog/digital (A/D) converted and being imaged processed by the control device CONT, the X coordinate of the mark 12 for X detection is detected by taking the indicator marks 20A and 20B as a standard. On the other hand, the photographic element for the Y axis outputs the photographic signal SY (luminance data) shown in FIG. 4C. In FIG. 4C, a signal section 22Y corresponds to the pattern portion 11L of the mark 12 for Y detection, and, by this photographic signal SY being analog/digital (A/D) converted and being imaged processed by the control device CONT, the Y coordinate of the mark 11 for Y detection is detected by taking the indicator marks 20C and 20D as a standard.

Furthermore, the control device CONT obtains the coordinates of the alignment mark 1 in the stage coordinate system based upon the results of measurement of the substrate stage PST which are outputted by the laser interferometers 7 for the X axis and for the Y axis when the alignment mark 1 has been photographed. This type of technique for photographing an image of the alignment mark 1 with the photographic elements to obtain the coordinate values of the alignment mark 1 is termed the FIA (Field Image Alignment) type, and, in this embodiment, it will be supposed that an alignment process of the FIA type using the alignment optical system 9 is performed, and furthermore that the alignment mark which consists of lines and spaces which is used in this embodiment is a two dimensional mark which is detected by the alignment detection system of the FIA type, so that it is possible to perform position detection in the X axis direction and in the Y axis direction with a single mark. It should be understood that although, in the above explanation, it has been assumed that it is a FIA type system which images the image of the alignment mark 1 upon the indicator plate, it would be the same if the construction were to be such that the indicator plate was arranged upon another optical path from the optical path of the detection light for alignment, and the image of the alignment mark and the image of the indicator mark were imaged upon a photographic element.

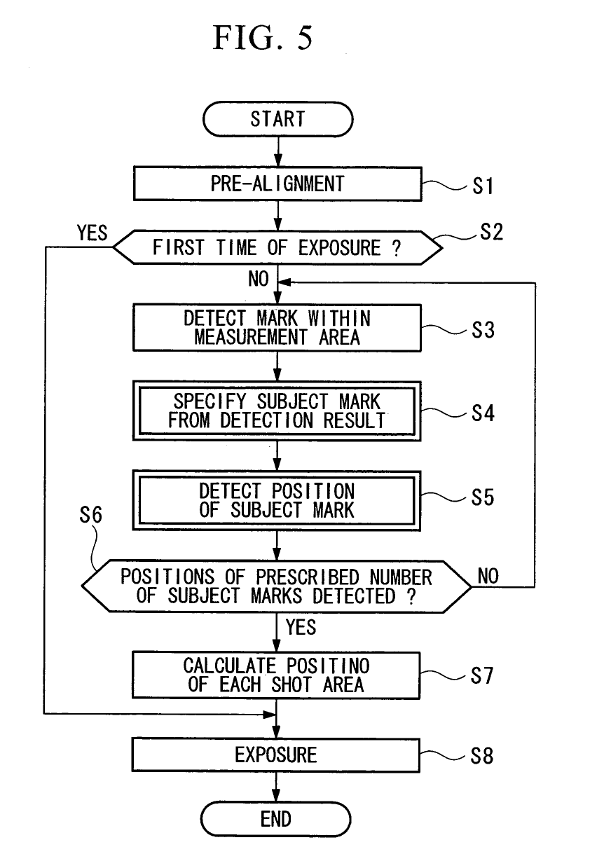

Next, a method for detecting an alignment mark which is formed upon the photosensitive substrate P by using the exposure device EX which comprises the alignment optical system (position detection device) 9 having the above described structure, and for performing processing for exposure to light, will be explained while referring to FIGS. 5 through 7.

FIG. 5 is a flow chart showing a summary of the operation of the exposure device EX. A summary of this operation will now be explained while referring to FIG. 5, with the main emphasis, among the operations of the exposure device EX, being upon the alignment procedure.

First, the mask M and the photosensitive substrate P are carried to the mask stage MST and the substrate stage PST respectively. Here, when carrying the photosensitive substrate P to the substrate stage PST and supporting it thereupon, preliminary position alignment of the photosensitive substrate P with respect to the substrate stage PST is performed (in the step S1) using an orientation flat or a notch or the like, according to the physical shape of the photosensitive substrate P, for example if the photosensitive substrate P is a wafer.

It should be understood that although, here, the positional alignment when carrying the photosensitive substrate P to the substrate stage PST and supporting it thereupon is termed a “pre-alignment procedure”, it could also be the case that a preliminary positional alignment is performed using the physical shape of the photosensitive substrate P, upon the substrate transportation path, before the photosensitive substrate P is supported upon the substrate stage PST; or it could be the case that a preliminary positional alignment is performed using the physical shape of the photosensitive substrate P, both upon the transport path before the photosensitive substrate P is supported upon the substrate stage PST, and also directly before the photosensitive substrate P is supported upon the substrate stage PST; and such procedures are also termed “pre-alignment procedures”.

Next, the exposure device CONT decides (in the step S2) whether this processing of the photosensitive substrate P for exposing it to light is the first episode of processing for exposure to light or not, in other words whether this is the first layer of pattern transcription for the photosensitive substrate P, or whether it is the second or a subsequent layer of pattern transcription.

If it is decided that this is the first episode of processing for exposure to light, then the control device CONT, while shifting the mask stage MST which supports the mask M and the substrate stage PST which supports the photosensitive substrate P in synchrony with one another, also illuminates the mask M with the exposure light EL by the illumination optical system IL, and thus exposes to light the pattern upon the mask M via the projection optical system PL onto each of the shot regions of the photosensitive substrate P (in the step S8).

At this time, the shot arrangement is performed based upon the design data (the shot map data).

On the other hand, if in the step S2 it is decided that this is the second or a subsequent episode of processing for exposure to light for the photosensitive substrate P, then the control device CONT detects the mark within the measurement region with the alignment optical system 9 (in the step S3).

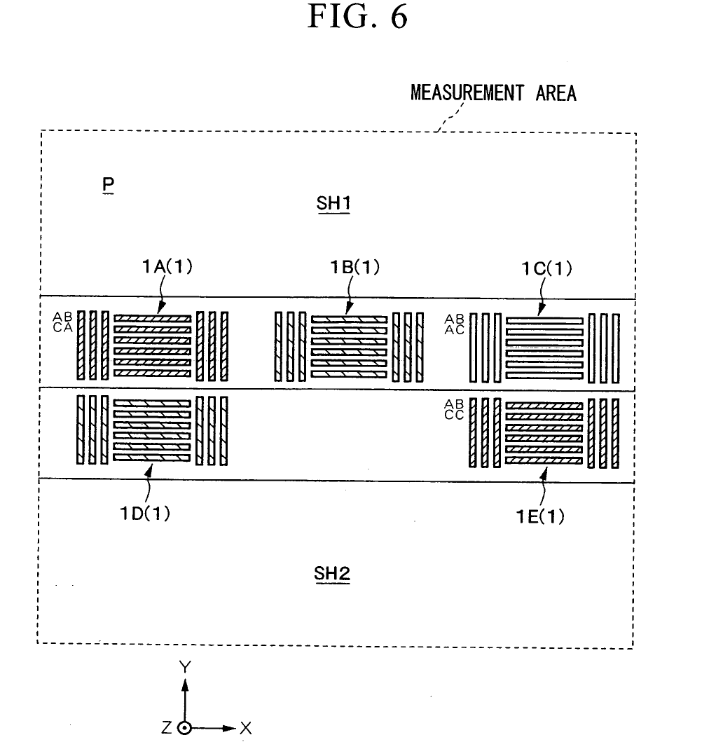

Here, as will be explained subsequently using FIG. 6, it may be the case that both alignment marks which are to be used for the alignment procedure and also alignment marks which are not to be used for the alignment procedure are mixed together within the measurement region of the alignment optical system 9. The control device CONT identifies and specifies (in the step S4) those alignment marks which are to be used for the alignment procedure, among the plurality of alignment marks which are mixed together within the measurement region of the alignment optical system 9.

And, when the control device CONT has specified those alignment marks from the plurality of alignment marks which are to be used in the alignment procedure, it detects the positions (the coordinate values in the stage coordinate system) of these alignment marks which it has specified (in the step S5).

Next, the control device CONT determines whether or not it has detected the position of the prescribed number of alignment marks (in the step S6).

If in the step S6 it is decided that the prescribed number has not been reached, then the control device CONT returns to the step S3. On the other hand, if it is decided that the prescribed number has been reached, then the control device CONT performs a statistical calculation procedure (an EGA procedure or the like) using the detected positions of the plurality of alignment marks, and performs position calculation of each of the shot regions (in the step S7).

And, having detected the positions of the predetermined alignment marks upon the photosensitive substrate P with the alignment optical system, and having performed positional alignment of the mask M and a shot region upon the photosensitive substrate P based upon a base line amount which is regulated in advance, the control device CONT shifts the photosensitive substrate P in order according to the calculated positions of each of the shot regions which were calculated in the step S7, and exposes the pattern image upon the mask M to light with the exposure light EL and projects it in the state in which the pattern image upon the mask M has been accurately superimposed upon and aligned with each of the shot regions. At this time, the base line amount which is used in the step S8 is measured in advance using a standard mark FM (refer to FIG. 1) which is provided upon the substrate stage PST.

It should be understood that the alignment procedure is constituted by a series of episodes of performing the steps S3 through S7, in which a plurality of alignment marks upon the photosensitive substrate P are detected and the detection of the position of each shot region (the EGA processing) is performed.

Here, upon the photosensitive substrate P, it may happen that a plurality of alignment marks are formed in respective correspondence to a plurality of shot regions; for example, it may happen that the respective alignment marks which have been provided corresponding to shot regions which adjoin one another may be disposed close to one another. In this case, it may happen that the alignment optical system 9 contains together this plurality of alignment marks which are close to one another within the measurement region at the same time. FIG. 6 is a figure showing a situation in which, a plurality of alignment marks 1A through 1E which are formed upon the photosensitive substrate P are arranged within the measurement region of the alignment optical system 9 at the same time.

As shown in FIG. 6, a plurality of alignment marks 1A through 1E are formed upon the photosensitive substrate P in respective correspondence to mutually adjacent shot regions SH1 and SH2, and this plurality of alignment marks 1A through 1E are detected at the same time within the measurement region of the alignment optical system 9. Among these, the alignment marks 1A, 1B, and 1C are ones which are formed to correspond to the shot region SH1, while the alignment marks 1D and 1E are ones which are formed to correspond to the shot region SH2.

Furthermore, a layered structure in which a plurality of layers are provided is formed upon the substrate: the alignment marks 1A and 1E are alignment marks which are formed upon the topmost layer (hereinafter for convenience termed the “No. 3 layer”); the alignment marks 1B and 1D are alignment marks which are formed upon the previous layer, in other words upon the layer below the No. 3 layer (hereinafter for convenience termed the “No. 2 layer”); and the alignment mark 1C is an alignment mark which is formed upon the previous to the previous layer, in other words upon the layer below the No. 2 layer (hereinafter for convenience termed the “No. 1 layer”). Since, in this manner, the fact that the alignment marks are in the state of being near to one another is because an alignment mark which is formed upon a previous layer is being observed, accordingly, in FIG. 6, the situation is shown in which the alignment marks which are formed upon the previous layer and upon the previous to the previous layer are visible from the alignment optical system 9 via the layers above.

And, with the identification mark 2 which is associated with the alignment mark 1A, the character pattern A is provided in the region R1, the character pattern B is provided in the region R2, the character pattern C is provided in the region R3, and the character pattern A is provided in the region R4. Furthermore, with the identification mark 2 which is associated with the alignment mark 1C, the character pattern A is provided in the region R1, the pattern B is provided in the region R2, the character pattern A is provided in the region R3, and the character pattern C is provided in the region R4. Moreover, with the identification mark 2 which is associated with the alignment mark 1E, the character pattern A is provided in the region R1, the character pattern B is provided in the region R2, the character pattern C is provided in the region R3, and the character pattern C is provided in the region R4. On the other hand, with the identification marks 2 which are associated with the alignment marks 1B and 1D, no character pattern is present in any of the regions R1 through R4. In this manner, the alignment marks 1A through 1E and the identification marks 2 which are associated with them are formed upon each of the layers, and the identification marks 2 are provided so that the information which is specified by the identification marks 2 is different for each of the layers.

In the following the case will be explained of aligning, in the step S4 shown in FIG. 5, a mask which has a circuit pattern for a subsequent layer with a shot region SH1 upon the photosensitive substrate P by using the alignment mark (the detection subject mark) 1A, among the plurality of alignment marks 1A through 1E which are contained together within the measurement region of the alignment optical system 9.

Here, process data containing information relating to the alignment marks which are to be the subjects of position detection (detection subject marks), shot map data including positional data for each shot region upon the photosensitive substrate P and positional data for the marks within each shot region, and mark information are stored in advance in the control device CONT (or in a storage device connected thereto).

The process data, for example, includes information such as “the alignment mark 1A is an alignment mark which is used in the alignment procedure when superimposing a subsequent layer circuit pattern over the No. 3 layer”. Accordingly, when performing processing for light exposure by using the mask M which includes the circuit pattern for the subsequent layer, the control device CONT refers to this process data, and performs the alignment procedure after determining upon all the alignment marks which are to be used (the marks which are to be the subjects of detection).

In the mark information, for example, there may be included information related to the forms and the positions of disposition of the three types of pattern A through C in the identification marks which are respectively associated with the plurality of alignment marks 1A through 1E, like “if, respectively, the character pattern A is disposed in the region R1, the character pattern B is disposed in the region R2, the character pattern C is disposed in the region R3, and the character pattern A is disposed in the region R4, then this alignment mark is 1A”. The control device specifies that the alignment mark 1A is that subject mark which has been detected from the plurality of alignment marks 1A through 1E by referring to this mark information.

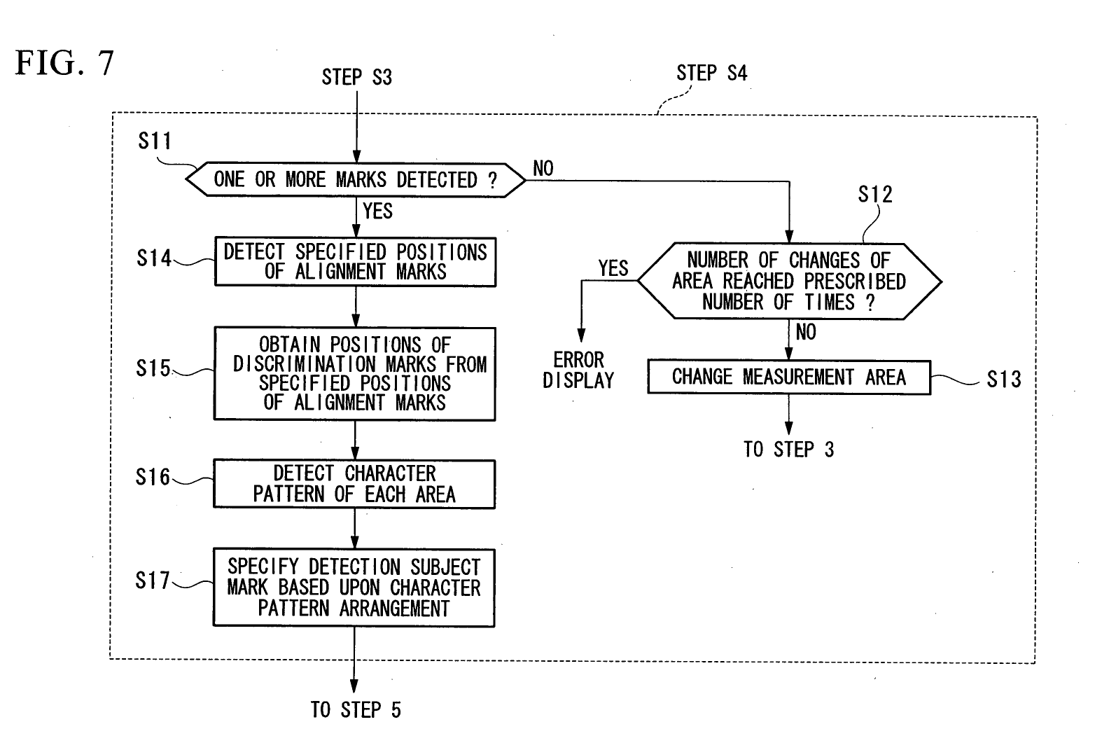

FIG. 7 is a flow chart (in other words, a detail diagram for the step S4 of FIG. 5) showing the procedure for identifying a specific alignment mark (a mark which is the subject of detection) which is to be used in the alignment procedure from the plurality of alignment marks 1A through 1E.

First, the control device CONT, as described above, detects the marks within the measurement region of the alignment optical system 9 (in the step S3).

Here, the control device CONT, along with determining the mark 1A which is to be the subject of detection by referring to the process data, also reads out the coordinate values of the mark 1A which is to be the subject of detection from the shot mark data, and drives the substrate stage PST based upon these coordinate values, and performs control so as to move this mark 1A which is to be the subject of detection into the measurement region of the alignment optical system 9. And the control device CONT performs mark detection by taking in and image processing the luminance data within the measurement region of the alignment optical system 9.

The control device CONT first makes a decision (in the step S11) as to whether or not one or more alignment marks have been detected within the measurement region of the alignment optical system 9.

In other words, since the positional accuracy of the photosensitive substrate P is low because its position is determined during the pre-alignment in the step S1, it sometimes happens that no mark is detected within the measurement region of the alignment optical system 9. Due to this, the control device CONT makes a decision as to whether or not there is a mark within the measurement region.

In the step S11, if it has been decided that no mark has been detected within the measurement region, the control device CONT makes a decision (in the step S12) as to whether or not the number of times that the measurement region has changed has reached a prescribed number of times.

In the step S12, if it is decided that the number of changes of region has reached a prescribed number of times, the control device CONT provides an error display. On the other hand, if it is decided that the number of changes of region has not reached the prescribed number of times, the control device CONT changes the measurement region (in the step S13).

And the control device performs mark detection using the alignment optical system 9 for the measurement region which has been changed (in the step S3).

It should be understood that the change of measurement region in the step S13 includes a procedure of taking the target coordinate value (the coordinate value of the mark 1A which is the subject of detection according to the shot map data) as a center, and changing to a lower or higher magnification by adjusting the alignment optical system 9 with respect to the measurement region, or a procedure of adding on a predetermined offset which is based upon the coordinate values of the subject mark for detection 1A from the shot map data as a compensation coordinate value, and shifting the measurement region based upon this compensation coordinate value, or the like.

On the other hand, in the step S11, if it has been decided that a plurality of alignment marks have been detected within the measurement region (in other words, if the situation has arrived at the one shown in FIG. 6), then the control device CONT detects each of the alignment marks 1A through 1E based upon the shot map data with the alignment optical system 9, performs image processing upon the observed images of each of the alignment marks 1A through 1E which have been detected by the alignment optical system 9, and obtains the specified position of each of these alignment marks 1A through 1E (in the step S14).

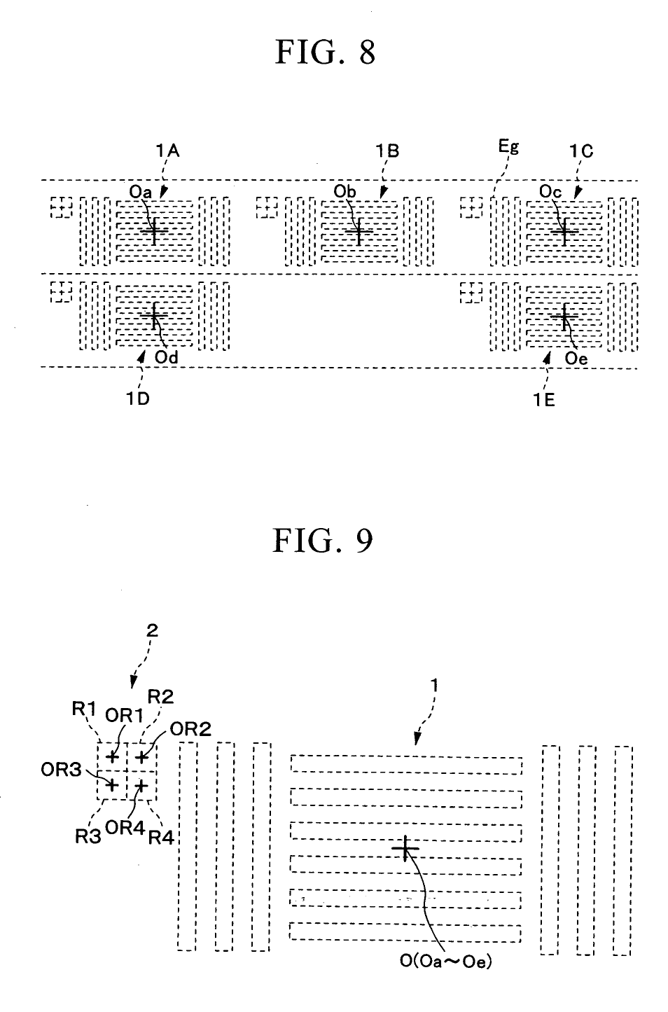

In other words, as has been explained using FIG. 2 and FIG. 4, the alignment mark 1 comprises a pattern portion and a space portion, and displays positional information by luminance data, when the observed image which has been observed by the position detection device (the mark detection device) of the image processing method which includes the alignment optical system 9 and the control device CONT has been image processed. Due to this, as shown in the schematic view of FIG. 8, the control device CONT performs image processing based upon the result of detection by the alignment optical system 9, and can obtain, for example, the central positions Oa through Oe of the alignment marks 1A through 1E. It should be understood that, as the specified positions of the alignment marks, the positions of their edges (in FIG. 7, refer to the reference symbol Eg), rather than the positions of their centers, would also be acceptable.

Next, the control device CONT obtains (in the step S15) the respective positions of the identification marks 2 which are associated with each of these alignment marks 1A through 1E from the specified positions Oa through Oe of the alignment marks 1A through 1E which have been obtained in the step S14.

In other words, as shown in the schematic figure of FIG. 9, the relative positions of the respective specified positions (the central positions) OR1 through OR4 of the regions R1 through R4 of the identification mark 2 with respect to the specified position (the central position) of the alignment mark 1 are set in advance, and this relative positional information is stored as the mark information (or as shot map data). The control device CONT refers to this mark information, and obtains the positions (the coordinates of the specified positions) OR1 through OR4 of the regions R1 through R4 of the identification mark 2 from the position (the coordinates of the specified position) O of the alignment mark 1 which have been detected in the step S14.

It should be understood that although, in this embodiment, the structure is such that the respective relative position of each of the regions R1 through R4 with respect to the central position O of the alignment mark 1 is obtained, it would also be acceptable, for example, to obtain the position (the relative position) OR1 of the region R1 which corresponds to the central position O of the alignment mark 1, and to obtain the respective positions (the relative positions) OR2 through OR4 of the regions R2 through R4 with respect to this position OR1 of the region R1 which has been obtained.

Next, the control device CONT observes, using the alignment optical system 9, each of the regions JR1 through R4 of the identification mark 2 which was obtained in the step S15, and detects the character patterns A through C which are respectively arranged in each of these regions R1 through R4 (in the step S16).

The control device CONT detects, using the alignment optical system 9, the images of the character patterns A through C which are formed in each of the regions R1 through R4 of the respective identification marks 2 which are associated with the alignment marks 1A through 1E which were obtained in the step S15, image processes these observed images, and obtains the forms (the shapes) of the character patterns which are respectively arranged in each of the regions R1 through R4. Here, the control device CONT compares together standard images which are stored in advance as mark information, and the observed image which has been detected by the alignment optical system, and, by a pattern matching method which derives the degree of similitude of these two images, obtains the shape of the character patterns which are disposed in each of these regions R1 through R4. Since the identification mark 2 is made up of a character pattern which displays 3⁴ types of information when the observed image which has been observed by the position detection device of the image processing method which includes the alignment optical system 9 and the control device CONT has been image processed, accordingly the control device CONT performs image processing based upon the results of detection by the alignment optical system 9, and is able to obtain the shape of the character pattern based upon a pattern matching method.

Next, the control device CONT refers to the mark information, and, based upon the information related to the shape and the positioning of the character pattern of the identification mark 2 which has been obtained in the step S16, specifies, from the plurality of alignment marks 1A through 1E, the mark 1A which is to be the subject of detection using the alignment procedure (in the step S17).

And the control device CONT determines that the alignment mark which is used in the alignment procedure is 1A.

When it has determined that the alignment mark which is used in the alignment procedure is 1A, the control device CONT aligns the mask M and the shot region SH1 of the photosensitive substrate by using this alignment mark 1A (in the step S5).

In the following, after having performed position calculation for each shot region, as has been explained using FIG. 5, processing for exposure to light is performed.

As has been explained above, by providing the identification marks 2 so as to associate them in a predetermined positional relationship with respect to the alignment marks 1 for outputting the positional information for the photosensitive substrate P (the shot regions), by detecting the form of this identification mark 2, even if the same types of alignment mark 1B through 1E are present adjacent to the alignment mark 1A which is to be the subject of detection, it is possible to specify, from this plurality of alignment marks 1A through 1E, that alignment mark 1A which must be used in the alignment procedure. And, since the identification mark 2 is made up as a combination of four by disposing the three types of character pattern respectively in the four regions R1 through R4, it is possible to display the large number 3⁴ of types of information even without setting the region for formation of the alignment marks for disposing the alignment mark 1 upon the photosensitive substrate P to be wide, so that it is possible to identify the mark without narrowing down the region for circuit pattern formation upon the photosensitive substrate P, even if a large number of alignment marks of the same type are present within the measurement region in which a large number of alignment marks are formed for each layer.

It should be understood that although, in the above described embodiment, a structure is implemented in which the respective positions Oa through Oe of the plurality of alignment marks 1A through 1E within the measurement region are obtained, and, based upon this positional information which has been obtained, the position of the identification mark 2 (the positions of the regions R1 through R4) are obtained while referring to the mark information, and the forms of the character patterns A through C which are respectively disposed in these regions R1 through R4 are obtained by a pattern matching method, it would also be acceptable, without performing position detection of the alignment marks 1A through 1E, to determine the positions of each of the identification marks 2 based upon the shot map data, and to specify the identification mark 2 by performing character pattern detection. And, since the identification marks 2 and the alignment marks 1 are arranged in a predetermined positional relationship, it is possible to specify that alignment mark 1A which must be utilized in the alignment procedure based upon the positional information for the identification mark 2 which has been specified.

In the above described embodiment, the character patterns are the alphabetic characters A through C, but of course they are not limited to being alphabetic characters; it would be acceptable for them to be patterns which specify Nⁿ types of information when the observed image which has been observed by the position detection device of the image processing method has been image processed; for example, it would be acceptable to inscribe the digits “1”, “2”, and “3”, or to inscribe characters including hiragana (conventional Japanese syllabic letter) or katakana (modified Japanese syllabic letter), or patterns such as “◯”, “Δ”, and “□”.

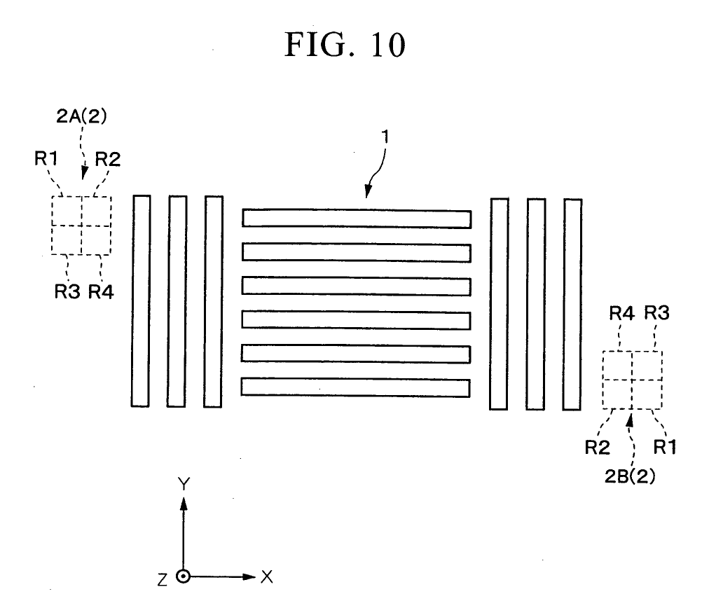

Although, in the above described embodiment, the structure was such that the identification marks 2 included the four regions R1 through R4, and one thereof was provided for each one of the alignment marks 1, it would also be acceptable, as shown in FIG. 10, to employ a structure in which two identification marks 2A and 2B were provided for a single alignment mark 1. By doing this, it is possible to display 38 types of information by disposing, for example, three types of character pattern A through C respectively in the regions R1 through R4 of the two identification marks 2A and 2B. And the number of the identification marks 2 is not limited to being two; it would be acceptable to provide them in any plurality of three or more. Here although, in FIG. 10, for the identification mark 2A which is located at the upper left and the identification mark 2B which is located at the lower right with respect to the alignment mark 1, for which the relative position with respect to the alignment mark 1 is the same when, for example, the photosensitive substrate P is reversed up and down (when it is rotated through 180° about the Z axis), the chance of the occurrence of the inconvenience that the control device CONT might cease to be able to tell the difference between the identification marks 2A and 2B, when they have been detected by the measurement region of the alignment optical system 9, might be considered to be a possibility, nevertheless since, before performing mark detection by the alignment optical system 9, the pre-alignment procedure for the photosensitive substrate P is performed upon the substrate stage PST using the physical shape of the photosensitive substrate P (its orientation flat or notch or the like), and so the control device CONT is aware in advance of the position of the photosensitive substrate P in the upwards and downwards direction, accordingly there is no obstacle to the employment of this alignment procedure which utilizes the alignment optical system 9.

### Second Embodiment

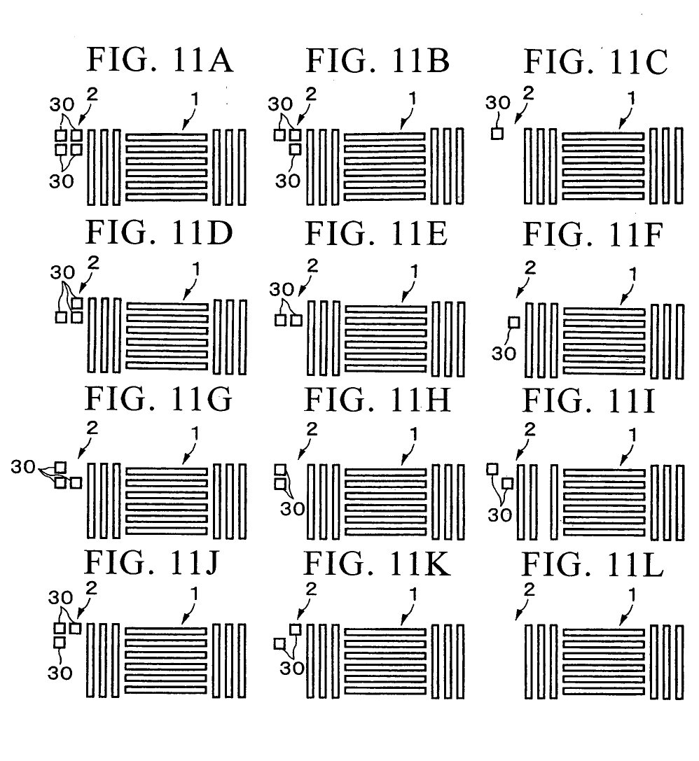

Next, the second embodiments of the mark for position detection and the mark identification method of the present invention will be explained with reference to FIGS. 11A through 11I. Here, in the following explanation, to structural elements which are the same as ones in the first embodiment described above or which are equivalent thereto, the same reference symbols will be affixed, and their explanation will be curtailed.

In FIGS. 11A through 11I, the identification mark 2 is made as an assembly of bit marks 30. Although in this embodiment the bit marks 30 are “□”, it would also be acceptable for them to be “◯” or “Δ”. Just as in the first embodiment, each of these bit marks 30 is formed in a respective region R1 through R4 which is set in a predetermined positional relationship with respect to the alignment mark 1. It should be understood that the number of regions of the identification mark 2 is not limited to four; it would be acceptable for it to be any natural number n greater than or equal to two.

In the example shown in FIG. 11A, a bit mark 30 is provided in each of the regions R1 through R4. Furthermore, in the example shown in FIG. 11B, bit marks 30 are provided in each of the regions R1, R2, and R4, but no bit mark 30 is present in the region R3. Yet further, in the examples shown in FIGS. 11C and 11F, one bit mark 30 is provided for each of the alignment marks 1; and, in FIG. 11C, the bit mark 30 is provided in the region R1, while in FIG. 11F the bit mark 30 is provided in the region R4. Even further, in the example shown in FIG. 11I, no bit marks 30 are provided in any of the regions R1 through R4. In this manner, with the identification mark 2, based upon the number and the arrangement of regions among the four regions R1 through R4 in which a bit mark 30 is provided and regions in which a bit mark 30 is not provided, it is possible to present 2⁴ types of information by combining four examples of the two types of mark—whether the bit mark 30 is present, or is absent—if the fact that no bit mark 30 is present is taken as being one type.

When specifying that alignment mark 1, from the plurality of alignment marks 1 with which these bit marks 30 are associated, which should be utilized in the alignment procedure, the control device CONT detects the respective specified positions O of the plurality of alignment marks 1 by the same procedure as was explained using FIG. 9, refers to the bit map data, and specifies the respective position of the regions R1 through R4 for the alignment marks 1. Here, if information related to the positions of the regions R1 through R4 is present in the bit map data, then, without detecting the specified position O of the alignment mark 1, it specifies the respective positions of the regions R1 through R4 based upon the information. And, by the same procedure as was explained using FIG. 4, the control device CONT scans the photographic element for the X axis and the photographic element for the Y axis of the alignment optical system 9 with respect to these respective regions R1 through R4 which have been specified, and detects whether a pattern has been provided, or whether no pattern has been provided, in each of the regions R1 through R4. And, based upon the arrangement information for the bit marks 30 which has been detected, and the mark information which is stored in advance, the control device CONT specifies that alignment mark from the plurality of alignment marks which should be utilized in the alignment procedure.

Since, in this manner, it is arranged to identify the identification mark 2 according as to which regions, among the four regions R1 through R4, patterns are provided in and which regions patterns are not provided in, therefore, even if, as for example in the example shown in FIGS. 11C and 11F, the structure is such that one bit mark 30 is provided for the alignment mark 1, it is possible, by detecting whether this bit mark 30 is provided in the region R1 or whether it is provided in the region R4, to identify that, in FIG. 11C and FIG. 11F, the identification marks are different.

It should be understood that although, in the above described example, the case was explained in which the identification mark 2 was identified according as to which regions, among the regions R1 through R4, a bit mark 30 was provided in and which regions a bit mark 30 was not provided in, it is also possible, for example, after having detected the number of the bit marks 30, to detect the position with respect to the specified position of, for example, an edge portion or the like of the alignment mark 1 for each of these bit marks 30 which have been detected, and to identify a identification mark 20 based upon the number of bit marks 30 and their arrangement (the number and the arrangement of the regions in which the bit marks 30 are provided). Furthermore, instead of obtaining the relative positions of each of the regions R1 through R4 with respect to the specified position of the alignment mark 1 (the relative positions of the bit marks 30 with respect to the specified position of the alignment mark 1), it would also be acceptable to obtain the relative position of each of the regions R1 through R4 itself, and to identify the identification mark 2 based upon these relative positions of the regions R1 through R4 themselves which have been obtained, and upon the number of the bit marks 30.

As has been explained above, a structure is also possible in which the identification mark 2 is built up by arranging respective bit marks 30 for each of n regions R1 through Rn; and, by doing this, it is possible to specify 2ⁿ types of information. And, by building up the identification mark 2 with the bit marks 30, there is no requirement for complicated image processing like a so called pattern matching method—in which feature this embodiment is different from the first embodiment—so that it is possible to perform the mark identification with a comparatively simple image processing procedure.

### Third Embodiment

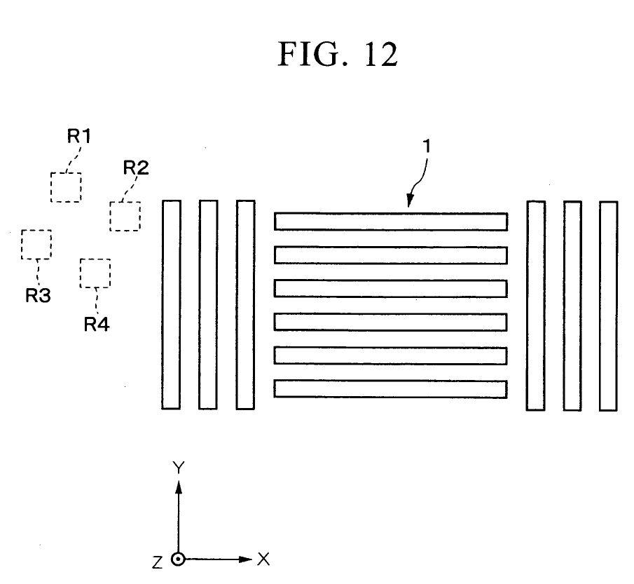

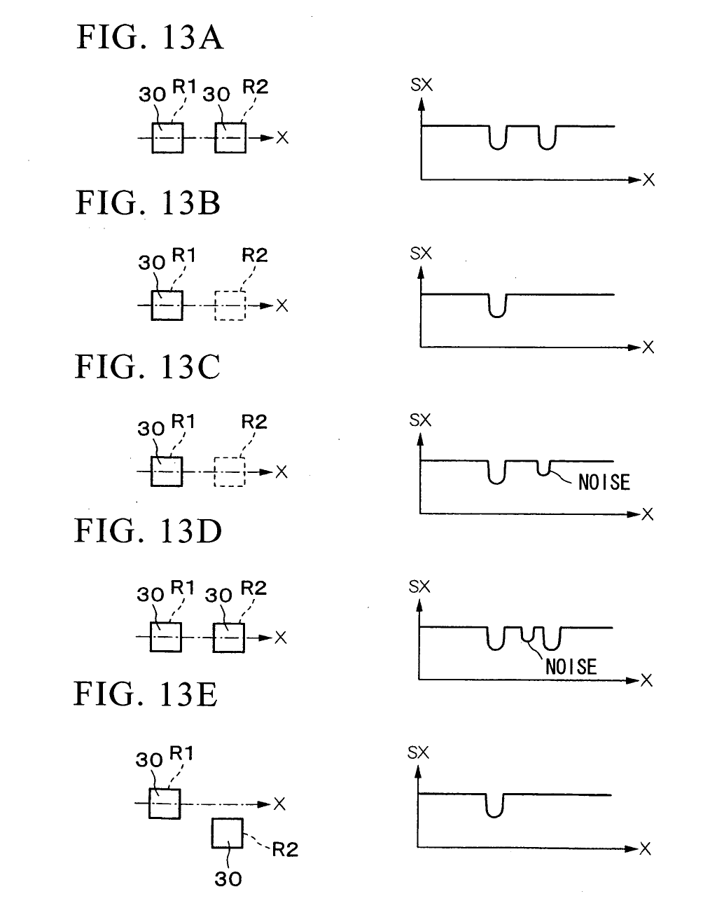

Next, the third embodiment of the present invention will be explained with reference to FIGS. 12 and 13A through 13E.

In FIG. 12, each of the four regions R1 through R4 of the identification mark 2 is arranged so that they almost do not mutually overlap in the X axis direction and in the Y axis direction. And, by arranging the bit marks 30 which were explained in the second embodiment in each of these regions R1 through R4, it is possible to enhance the detection accuracy of the bit marks 30 by the alignment optical system 9, and thus to enhance the identification accuracy of the identification mark 2.

In other words although, as described above, the bit marks 30 are detected by scanning the photographic element for the X axis and the photographic element for the Y axis, if, for example, as shown in FIG. 13A, the region R1 and the region R2 are set along the X axis direction, and the bit marks 30 are individually provided in each of the region R1 and the region R2, then the number of peaks of the photographic signal SX which is detected by the photographic element is two. On the other hand, if as shown in FIG. 13B a bit mark 30 is provided in the region R1, but no bit mark 30 is provided in the region R2, then the number of peaks in the photographic signal SX is one. However it may happen that, as shown in FIG. 13C, a bit mark 30 is provided in the region R1, while, although no bit mark 30 is provided in the region R2, nevertheless, due for example to noise or the like, a signal peak is generated in the portion which corresponds to the region R2. In this case, there is a danger that, regardless of the fact that there is no bit mark 30 in the region R2, it will be mistakenly detected that there is a bit mark 30 in the region R2. Furthermore even if, as shown in FIG. 30D, bit marks 30 are provided both in the region R1 and in the region R2, when due to noise, for example, three peaks are present, then it may happen that it becomes difficult to be certain which ones, among these three peaks, correspond to the bit marks 30 which are provided in the region R1 (or in the region R2). However by, as shown in FIG. 13E, arranging the region R1 and the region R2 so as not to overlap with one another in the X axis direction, since the number of peaks of the photographic signal which are related to the bit mark 30 which is provided in the region R1 (or in the region R2) is one, then it is possible easily to be certain of the noise component, even if noise or the like is carried in the photographic signal SX, since it is possible to determine that the signal peaks other than the portions which correspond to the region R1 are ones which are based upon noise. And thus it is possible to enhance the detection accuracy of the bit marks 30 by arranging each of the regions R1 through R4 so that they do not overlap in the X axis direction (or in the Y axis direction).

It should be understood that although, in this embodiment, each of the regions R1 through R4 is set to a position in which they do not overlap either in the X axis direction or in the Y axis direction, it would also be acceptable to set them to positions in which they did not overlap in one of either the X axis direction or the Y axis direction.

### Fourth Embodiment

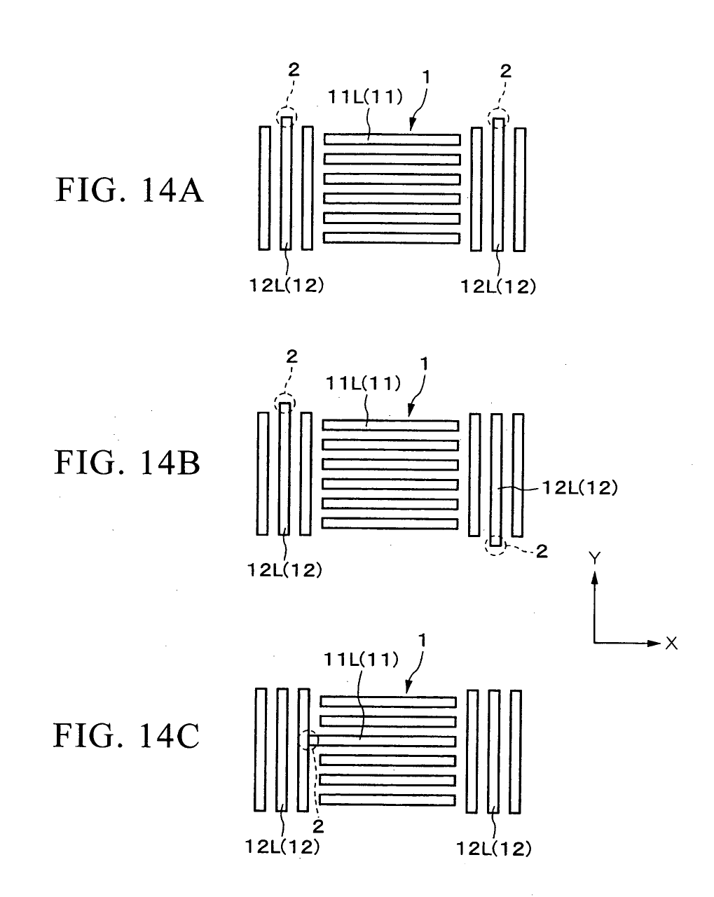

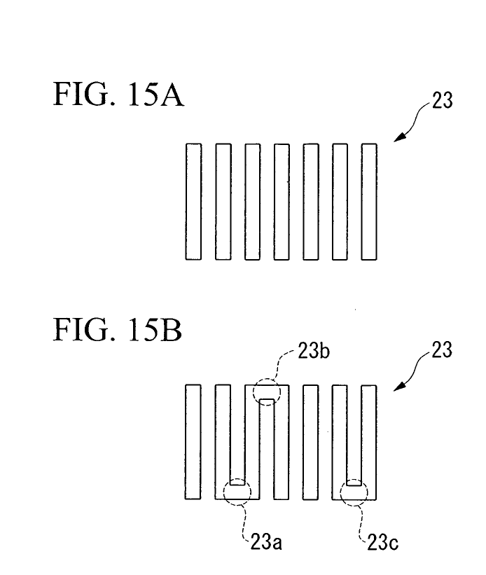

Next, the fourth embodiment of the present invention will be explained with reference to FIG. 14.

As shown in FIGS. 14A through 14C, the identification marks 2 are arranged to extend along the prolongation of the direction of extension of the pattern portions of the alignment mark 1. In the example shown in FIG. 14A, the identification mark 2 is provided in a position which continues to the +Y side of the pattern portions 12L which extend in the Y axis direction among the alignment marks 1, and is provided on the +Y side of the central pattern portion 12L among the three pattern portions 12L which are provided in the illustrated mark 11 for Y detection upon the left side, and on the +Y side of the central pattern portion 12L among the three pattern portions 12L which are provided in the illustrated mark 11 for Y detection upon the right side. In the example shown in FIG. 14B, the identification marks 2 are provided on the +Y side of the central pattern portion 12L among the three pattern portions 12L which are provided in the illustrated mark 11 for Y detection upon the left side and on the −Y side of the central pattern portion 12L among the three pattern portions 12L which are provided in the illustrated mark 11 for Y detection upon the right side. In this manner it is possible to provide 2¹² types of information by providing the identification marks 2 so as to continue towards either the +Y side and the −Y side of each one of the total of six pattern portions 12L of the mark 12 for X detection.

It should be understood that, in the identification mark 2, apart from continuation in the pattern portions 12L of the marks 12 for X detection, continuation is also possible in the pattern portions 11L of the marks 11 for Y detection. For example, in the example shown in FIG. 14C, in the identification mark 2, among the six pattern portions 11L of the mark 11 for Y detection, in the figure, continuation is provided on the −X side of the third pattern portion from the top. It should be understood that, in the example shown in FIG. 14C, with the structure in which the identification mark 2 is disposed in the detection region 21X (refer to FIG. 4) of the photographic element for the X axis of the alignment optical system 1, there is a danger of exerting an influence upon the alignment procedure. Accordingly, in this embodiment, from the standpoint that it is desirable not to dispose the identification mark 2 in the detection regions 21X and 21Y of the photographic elements, as shown in FIGS. 14A and 14B, a construction is desirable in which the identification marks 2 are arranged upon the prolongation in the extension direction of the pattern portions 12L of the marks 12 for X detection. In other words, in this embodiment, in the outer side portions of the detection regions 21X and 21Y of the photographic elements of the alignment optical system 9, the identification marks 2 are arranged upon the prolongations in the extension direction of the pattern portions 12L.

It should be understood that, apart from forming identification marks by extending the lengths in the extension direction of the patterns for detection, as in this embodiment, it might also be considered to increase the number of patterns for detection. For example although, in this embodiment, the pattern portions 12L are formed on both sides of the mark 11 for Y detection at each third line portion, it would also be possible, by forming them with four lines at one side and three lines at the other side, or by forming four lines at each side, to identify them from marks in which three line portions at each side are formed.

Furthermore, if there is a dedicated X axis direction (or Y axis direction) detection mark 23 like the one shown in FIG. 15A, it would also be acceptable, as shown in FIG. 15B, to provide identification marks 23a, 23b, and 23c in such a state as to connect portions of adjacent line portions.

### Fifth Embodiment

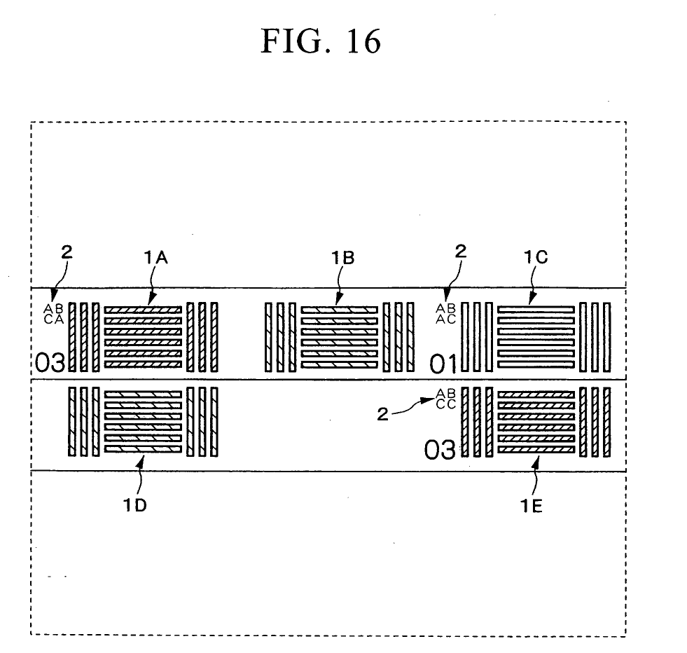

Next, the fifth embodiment of the present invention will be explained with reference to FIG. 16.

In FIG. 16, to each of the alignment marks 1, there is provided in association a mark for perception which is larger than the identification mark 2. In this embodiment, as the marks for perception, the character “03” is provided to the alignment marks 1A and 1E which are formed upon the No. 3 layer, while the character “01” is provided to the alignment mark 1C which is formed upon the No. 1 layer. By providing large marks for perception upon regions of the photosensitive substrate P which are not used in the alignment procedure or in the identification procedure in this manner, it is possible for the operator easily to perceive and to specify the predetermined alignment marks from the plurality of alignment marks. And, by setting the marks for perception to correspond to each layer, it is possible for the operator to reduce the occurrence of operator errors, since it is possible for him to grasp, for example, for which number layer processing is being performed, and the like.

It should be understood that, by detecting the shape of this mark for perception by a pattern matching method, it is possible to identify the alignment mark 1 based upon the result of this detection. In other words, it is also possible to utilize the mark for perception as the identification mark 2.

### Sixth Embodiment

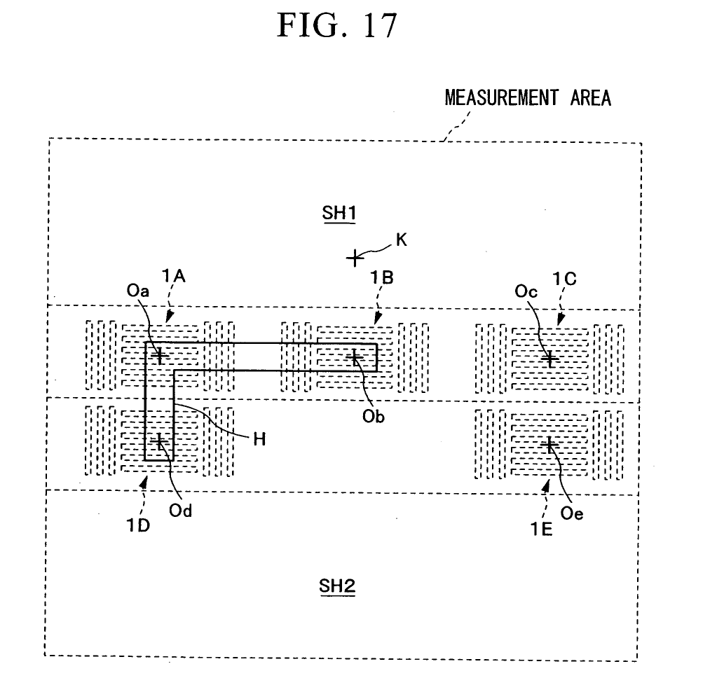

Next, the sixth embodiment of the present invention will be explained with reference to FIG. 17.

In this embodiment, a identification mark 2 is not provided to each of the alignment marks 1; the alignment optical system 9 specifies the detection subject mark from the alignment marks 1A through 1E which have been detected in the measurement region by utilizing an alignment procedure, based upon information related to the arrangement of the plurality of the alignment marks 1 which are detected within the measurement region. In the following explanation, the case of specifying the alignment mark 1A from the plurality of alignment marks 1A through 1E will be explained.

As shown in FIG. 17, a plurality of alignment marks 1A through 1E are contained together within the measurement region of the alignment optical system 9. First, the control device CONT obtains the specified positions (the central positions) Oa through Oe of each of these alignment marks 1A through 1E.

The control device CONT refers to the mark information an specifies the alignment mark 1A which is to be the detection subject mark from the arrangement of the central positions Oa through Oe which has been obtained. In other words, the control device CONT obtains each of the mutual relative positions of the central positions Oa through Oe, and, as shown by the solid lines in FIG. 17, takes the combination which consists of the arrangement H in which a letter “L” shape has been rotated through 90°. Since from the mark information the alignment mark 1A, which is present at the corner portion of this arrangement H, is the detection subject mark, accordingly the control device CONT specifies that this alignment mark 1A which is present in this corner portion as the detection subject mark. Here, if there is no arrangement H shown by the solid lines present within the measurement region, it adjusts the optical elements of the alignment optical system and widens the measurement region, and repeats this procedure until it finds a combination of alignment marks which does have an arrangement H. On the other hand, if a similar arrangement H is present within the measurement region, it shifts the measurement region or narrows it down, and adjusts the alignment optical system so that only a single desired arrangement H is present within the measurement region.

It should be understood—although it is clear from FIG. 17—that no problem arises with the arrangement H, even if it is an arrangement which is made up of an alignment mark 1A which is provided to correspond to one shot region SH1 and an alignment mark 1D which is provided to correspond to a shot region SH2 which is adjacent to the shot region SH1, or even if it is an arrangement which is made up of alignment marks for which the layers are mutually different, such as the alignment mark 1A and the alignment mark 1B.

It should be understood that although, in this embodiment, the relative positions of a plurality of alignment marks 1A through 1E are specified, and the detection subject mark is specified from this relative positional information, it would also be acceptable to arrange, for example, to obtain the respective relative positions of the alignment marks 1A through 1E with respect to the specified position of the circuit pattern which is formed upon the shot region (refer to the symbol K in FIG. 17), and to specify the detection subject mark 1A from the plurality of alignment marks 1A through 1E based upon this relative positional information with respect to this circuit pattern specified position.

### Seventh Embodiment

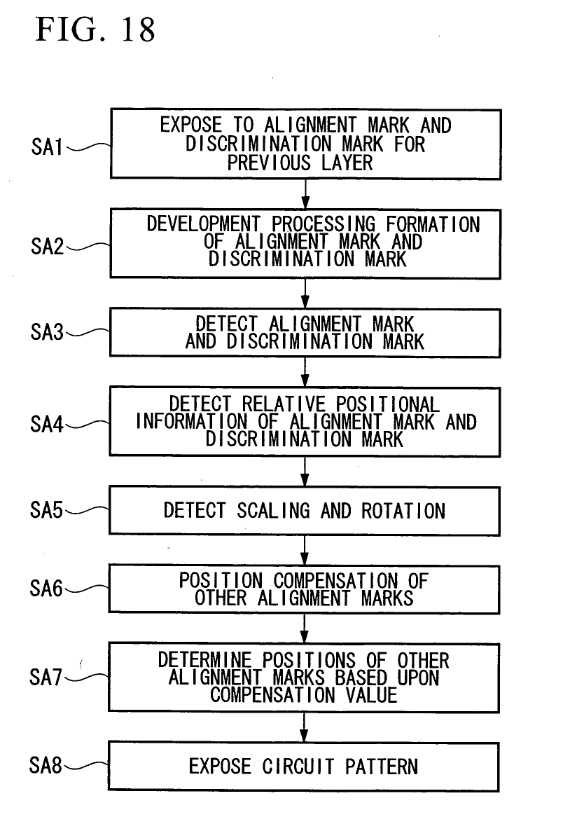

Next, the seventh embodiment of the present invention will be explained while referring to FIG. 18. FIG. 18 is a flow chart of the alignment procedure according to this embodiment.

The circuit pattern, the alignment mark, and the identification mark formed upon the mask M are transcribed onto a resist of the previous layer of the photosensitive substrate P by processing it by exposure to light. An image of the circuit pattern, the alignment marks, and the identification marks is formed upon the previous layer of the photosensitive substrate P (in the step SA1).

Development processing is performed upon the photosensitive substrate P upon which the image of the alignment marks and the identification marks has been transcribed. By this development processing, the alignment marks 1 and the identification marks 2 are formed in a predetermined positional relationship (in the step. SA2).

The photosensitive substrate P upon which the resist has been applied over the previous layer, after having been pre-aligned, is transported to the substrate stage PST of the exposure device EX. The control device CONT performs detection of the alignment marks 1 and the identification marks 2 which are formed upon the photosensitive substrate P by using the alignment optical system 9 (in the step SA3).

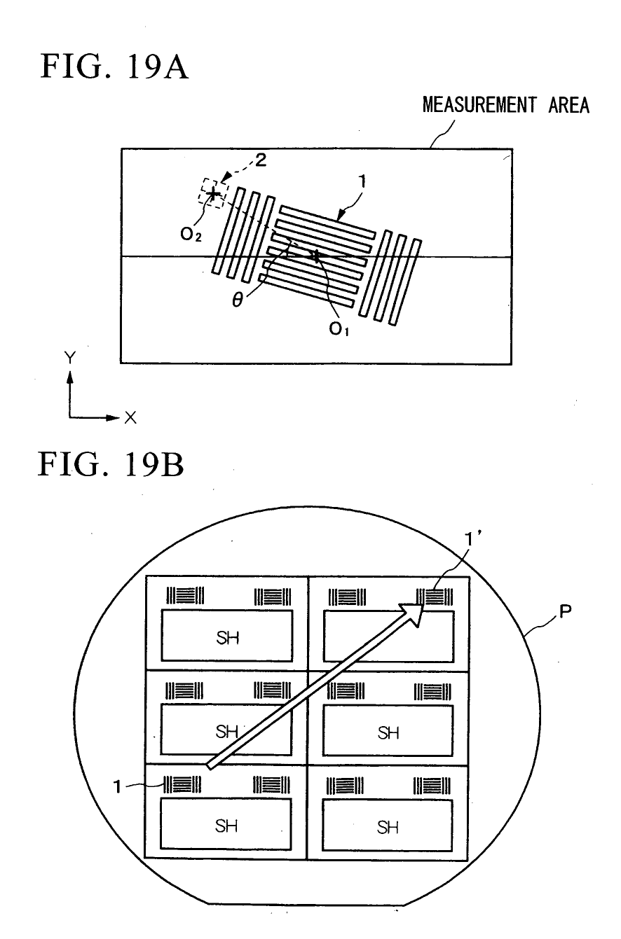

Here, as shown in FIG. 19A, the control device CONT detects the coordinates of the specified position (the central position) of the alignment mark 1 and the coordinates of the specified position (the central position) of the identification mark 2, and detects the relative positional information of the alignment mark 1 and the identification mark 2 based upon the coordinates which it has detected (in the step SA4).

Furthermore, from the relative positional information which it has detected, the control device CONT obtains (in the step SA5) the amount of change of the distance between the alignment mark 1 and the identification mark 2 from the time point at which the alignment mark 1 and the identification mark 2 were formed upon the photosensitive substrate P until the relative positional information is detected, or the amount of rotation of the photosensitive substrate P (the shot region) in a prescribed direction.

In other words, as shown in FIG. 19A, based upon the coordinates of the specified position O1 and the specified position O2, the control device CONT determines the amount of change of the distance of these specified positions O1 and O2, or the amount of rotation θ of the photosensitive substrate P with respect to the X axis direction, which is the standard axis. The scaling of the photosensitive substrate P (the shot region) is obtained from the amount of change of this distance, and the rotation of the photosensitive substrate P (the shot region) is obtained from the amount of rotation. Furthermore, in this case, it is also possible to detect information related to deformation of the photosensitive substrate P based upon the specified position O1, the specified position O2, and the relative positional information.

The control device CONT compensates the design position of the other alignment marks based upon the scaling and rotation which have been obtained (in the step SA6).

The control device CONT determines the position of the alignment marks other than the alignment mark 1 which has been detected based upon the compensation amount (in the step SA7).

That is to say, it is possible to utilize the alignment mark 1 as a search alignment mark, and, in such a case, as shown in the schematic view of FIG. 19B, the control device CONT comes to detect a plurality of marks which are separated upon the photosensitive substrate P with the alignment optical system 9, but it is possible to obtain information related to the scaling, rotation, or deformation of the photosensitive substrate P from the alignment mark 1 and the identification mark 2 shown in FIG. 19A, to derive a compensation amount based upon these results which have been obtained, and next to determine the positions of the other alignment marks 1′ which are detected based upon the compensation amount which has been derived. And, when shifting the substrate stage PST upon which the photosensitive substrate P is supported in order to detect the other alignment marks 1′ with the alignment optical system 9, the control device CONT is able to arrange the other alignment marks 1′ upon the photosensitive substrate P within the measurement region of the alignment optical system 9 quickly and smoothly. Here, it is also possible to obtain the shift component of the photosensitive substrate P (the shot regions) based upon the positional information of a plurality of the alignment marks 1. Furthermore, to draw a comparison with a prior art method in which, after detecting the positional information for two search alignment marks and detecting the scaling information, the rotation information, and the substrate deformation information (collectively termed “search information”), for example eight other fine alignment marks are detected as search marks for performing fine alignment by an EGA method, whereas with the prior art method it was necessary to shift the photosensitive substrate in order to obtain the search information, with this embodiment, the situation is more desirable from the point of view of enhancing the throughput, due to the two features that: (a) it is not necessary to shift the photosensitive substrate in order to determine the search information; and (b) it is not necessary to shift the photosensitive substrate very far, in order to shift one of the fine alignment marks, among the eight fine alignment marks, into the field of view.

When the alignment procedure has been completed, the exposure device EX exposes the circuit pattern upon the mask M to light onto the subsequent layer upon the photosensitive substrate P (in the step SA8).

It should be understood that, in this embodiment, the detection of the relative positional information of the alignment mark 1 and the identification mark 2 has been explained as being performed at the time of the search alignment procedure, but it would also be acceptable, for example, to perform it at the time of the pre-alignment procedure.

Furthermore although, in this embodiment, the scaling information and so on was obtained by detecting the specified position O1 of the alignment mark 1 and the specified position O2 of the identification mark 2, from the point of view of accuracy, it is more desirable, when obtaining the scaling information and the rotation information, for the distance between the two detection points to be great. Thus, it is desirable to form a second identification mark at a position which is the symmetric point to the identification mark 2 when the center of the alignment mark 1 is taken as the point of symmetry, and to obtain the scaling information and the rotation information and so on from the specified position of this second identification mark, and the specified position O2 of the original identification mark 2. Yet further, the same beneficial result may also be obtained by increasing the distance between the alignment mark 1 and the identification mark 2.

### Eighth Embodiment

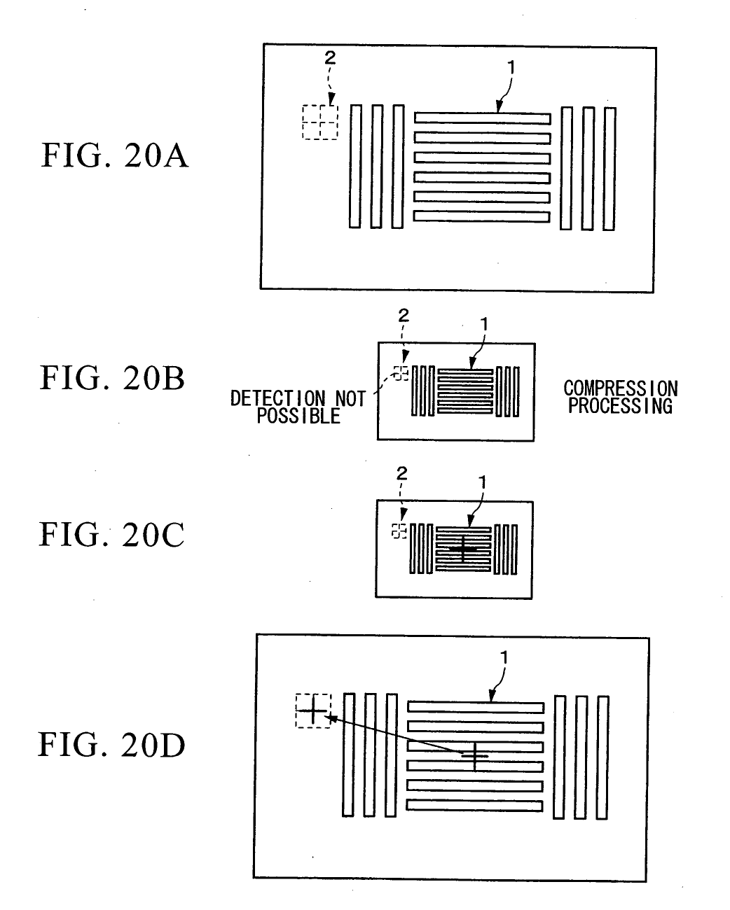

Next, the eighth embodiment of the present invention will be explained with reference to FIGS. 20A through 20D.

If the alignment mark 1 and the identification mark 2 shown in FIG. 20A are detected by the mark detection device of the image processing method which includes the alignment optical system 9 and the control device CONT, then it is possible, by performing the mark detection after having performed compression processing upon the image data which has been photographed, as shown in FIG. 20B, to enhance the processing speed over the case in which compression processing is not performed. However, since the identification mark 2 is a smaller mark than the alignment mark 1, it may happen that the mark image is spoiled by performing compression processing, so that it becomes impossible to perform position detection upon the identification mark 2, or that by performing the compression processing the identification mark 2 becomes undesirably small, so that it takes an extremely long time to extract it from within the entire photographic screen.

In this case, as shown in FIG. 20A, after having photographed an image of the measurement region and having acquired the image data, the mark detection device compression processes the image data as shown in FIG. 20B, and next, as shown in FIG. 20C, detects the position of an alignment mark 1 (the first mark) as a non subject mark which is in a predetermined positional relationship with respect to the identification mark 2 (the second mark) which is the subject of detection and which moreover is bigger than the identification mark 2, and is able to obtain the position of the identification mark 2 from the image data which it has obtained by photographing the measurement region, based upon this positional information for the alignment mark 1 which it has detected, and the relative positional information for the alignment mark 1 and the identification mark 2 which is obtained in advance. And, as shown in FIG. 20D, after returning the image which has been compressed to its original state, the mark detection device performs detection of the shape of the character pattern of the identification mark 2. According to this method, since it becomes possible to squeeze down the range which is occupied by the identification mark 2, it is possible to shorten the time period to less than would be required, if taking a identification mark which, undesirably, had become smaller from the entire compressed image.

As has been explained above, when detecting a identification mark 2 which is smaller than the alignment mark 1, by detecting an alignment mark 1 which can be easily detected by the mark detection device, in other words which has a greater surface area than the identification mark 2 and whose ease of detection is high, and which moreover is in the prescribed positional relationship with the identification mark 2, after detecting the alignment mark 1 with high speed processing, it is possible to perform detection of the identification mark 2 with good efficiency, based upon the detection result of the alignment mark 1 and the prescribed positional relationship.

It should be understood that although, in this embodiment, the detection method is one which detects the position of the alignment mark 1 which is larger than the identification mark 2 which is the detection subject mark, and detects the position of the identification mark 2 based upon the result of this detection, it would also be acceptable, as a detection method, to detect the positional information for a non subject mark which is in a predetermined positional relationship with respect to the detection subject mark and moreover for which, for example, the luminance data of the image which is photographed by the alignment optical system is alike, and to perform position detection of the detection subject mark based upon this detection result. Here, by a mark of which the luminance data is alike, is meant a mark for which the value of the scattering of the image data (the luminance data) is small, and the control device CONT is able to detect in a short time period the position for which the scattering value is the smallest in the measurement region of the alignment optical system (the photographic element), in other words the position of the non subject mark. In this manner, if the non subject mark is in a predetermined positional relationship with respect to the detection subject mark, and has a shape for which position detection is possible at high speed (the ease of detection is high) according to the image processing method of the mark detection device (the detection method), then, by performing position detection of this non subject mark, based upon the result of this detection, it is possible to detect the position of the subject mark in a short time period.

### Ninth Embodiment

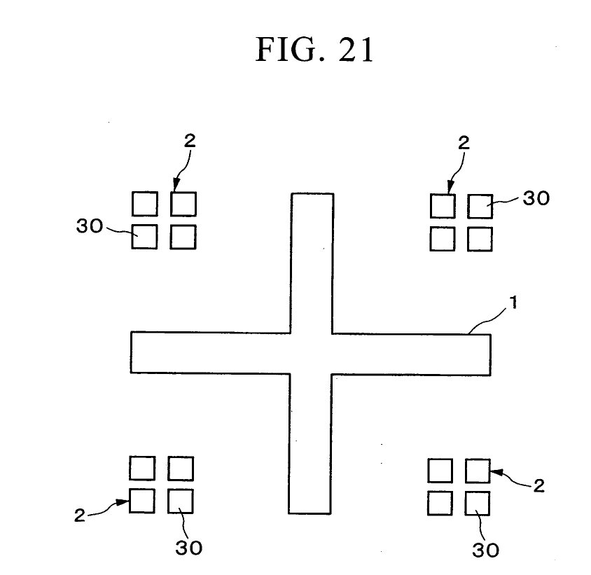

Next, the ninth embodiment of the present invention will be explained with reference to FIG. 21.

As shown in FIG. 21, identification marks (non subject marks) 2 are provided at almost equal spacing around an alignment mark 1 (the subject mark). In this embodiment, the alignment mark 1 is a cross shaped mark, while four of the identification marks 2 are provided at four places at equal spacing around the vicinity of the alignment mark 1. Furthermore, in each of the identification marks 2, there are disposed bit marks 30 in each of four regions R1 through R4.

It should be understood that here by “spacing” is meant that, in FIG. 21 as an example, at least one of the following conditions holds: that the distance from the vertical direction pattern portion of the cross shaped mark to the identification mark 2 in the upper right (the lower right) is equal to the distance from the vertical direction pattern portion of the cross shaped mark to the identification mark 2 in the upper left (the lower left); that the distance from the horizontal direction pattern portion of the cross shaped mark to the identification mark 2 in the upper right (the upper left) is equal to the distance from the horizontal direction pattern portion of the cross shaped mark to the identification mark 2 in the lower right (the lower left); and that the distance from the intersection point of the vertical direction pattern portion and the horizontal direction pattern portion of the cross shaped mark to the identification mark 2 in the upper right (the upper left) is equal to the distance from the intersection point to the identification mark 2 in the lower left (the lower right).

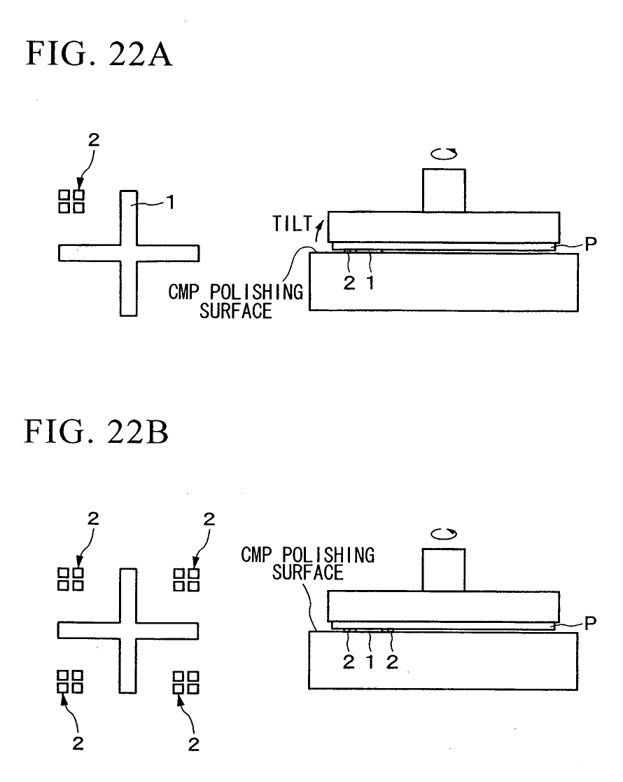

Although sometimes a CMP (chemical-mechanical polishing) procedure may be performed for flattening the surface of the photosensitive substrate P (the device surface) by employing this type of structure, as shown in the schematic view of FIG. 22A, when the non subject marks 2 in the neighborhood of the subject mark 1 are not provided at an equal spacing, it may happen that polishing takes place under the condition that the device surface is contacted at an angle with respect to the polishing surface of the CMP device, which is undesirable, and may lead to unevenness in the condition of the polishing. However, by providing the non subject marks 2 at an equal spacing in the vicinity of the subject mark 1, as shown in the schematic view of FIG. 22B, it is possible to avoid occurrence of the inconveniences that the condition of the polishing becomes uneven, or that only a portion of the subject mark 1 comes to be polished, since there is no inclined contact of the device surface against the polishing surface of the CMP device, and since the polishing is performed under the condition of an even contact.

It should be understood that, instead of providing the non subject marks 2 at an equal spacing around the vicinity of the subject mark 1, it would also be acceptable to arrange to protect the subject mark 1 by providing partition portions around the vicinity of the subject mark 1 and made from the same substance as the subject mark 1. Furthermore, if the line width of the subject mark 1 is minute, when image processing such as was described in the eighth embodiment described above is performed upon the image data, or when observation is performed by using an optical system of low magnification which can observe a wide area upon the substrate, it may happen that it is not possible to perceive the subject mark quickly. To address this matter, if the line width of the partition portions which are provided for protection of the subject mark 1 is made to be thicker than the line width of the subject mark 1, then satisfactory results can be obtained, even in the case that the image data is compressed, or that the marks are observed by employing an optical system of low magnification.

### Tenth Embodiment

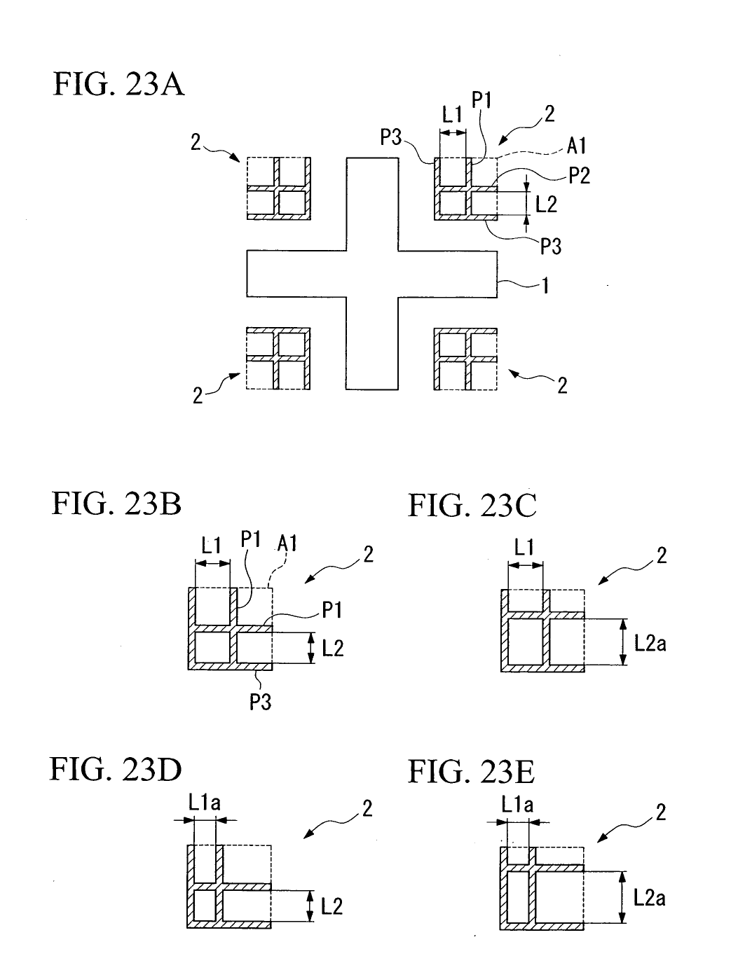

Next, the tenth embodiment of the present invention will be explained with reference to FIGS. 23A through 23E. It should be understood that in the following, for the convenience of explanation, the upwards and downwards direction in these figures will be supposed to be the “vertical direction”, while the leftwards and rightwards direction will be supposed to be the “horizontal direction”.

As shown in FIG. 23A, around the vicinity of an alignment mark region 1, there are provided four second mark regions A1 in a predetermined positional relationship with the alignment mark region 1, and vertical patterns P1 and horizontal patterns P2 are formed within these second mark regions A1. The vertical patterns P1 extend in the vertical direction within the second mark regions A1, and, with respect to the horizontal direction, are disposed at desired positions within the second regions. And the horizontal patterns P2 extend in the horizontal direction within the second mark regions A1, and, with respect to the vertical direction, are disposed at desired positions within the second mark regions A1. And information which is the same as the information of the first through the fifth embodiment described above is given by the positions of the intersection points of the vertical patterns P1 and the horizontal patterns P2. It should be understood that, in the example shown inn FIG. 23A, partition patterns P3 are also formed for protecting the first mark, as has been described above.

In the following, the method of giving information in this embodiment will be explained, with reference to FIGS. 23B through 23E, in relation to the second mark which is positioned at the upper right in FIG. 23A.

With the second mark 2 shown in FIG. 23B, a vertical pattern P1 is arranged at a position of length L1 from the left end portion in the figure of the second mark region A1, and, furthermore, a horizontal pattern P2 is arranged at a position of length L2 from the lower end portion in the figure of FIG. 23 of the second mark region A1. With the second mark 2 shown in FIG. 23C, the vertical pattern P1 is arranged at a position of length L1 from the left end portion in the figure of the second mark region A1, just the same as in FIG. 23B, while the length of the horizontal pattern P2 from the lower end portion in the figure of the second mark region A1 is L2a, which is longer than in FIG. 23B. With the second mark 2 shown in FIG. 23D, the horizontal pattern P2 is arranged at a position of length L2 from the lower end portion in the figure of the second mark region A1, just the same as in FIG. 23B, while the length of the vertical pattern P1 from the left end portion in the figure of the second mark region A1 is L1a, which is shorter than in FIG. 23B. And, with the second mark 2 shown in FIG. 23E, the length of the vertical pattern P1 from the left end portion in the figure of the second mark region A1 is Lla, which is shorter than in FIG. 23B, while the length of the horizontal pattern P2 from the lower end portion in the figure of the second mark region A1 is L2a, which is longer than in FIG. 23B.

As described above, by changing one or both of the horizontal position of the vertical pattern P1 and the vertical position of the horizontal pattern P2, the positions of the intersection points between the vertical pattern P1 and the horizontal pattern P2 are mutually changed, as in FIGS. 23A through 23E respectively. Accordingly, by establishing a correspondence between different items of information and these respective intersection points, it becomes possible to specify a large amount of information with the intersection points between the vertical pattern P1 and the horizontal pattern P2. With the above method, it is possible to display only a number of different items of information which is equal to the number of combinations of variation of the horizontal position of the vertical pattern P1 and of variation of the horizontal position of the horizontal pattern, although this also depends upon the resolving power of the detection device which detects the horizontal position of the vertical pattern P1 and upon the resolving power of the detection device which detects the vertical position of the horizontal pattern P2. Accordingly, as compared with the identification marks which employed bit marks as were explained for the second and the third embodiment described above, it becomes possible to make a great leap forward in increasing the number of items of information which can be displayed.

It should be understood that the alignment optical system for detecting the alignment mark which is formed in the alignment mark region 1—for example, the alignment optical system 9 which comprises a photographic element as shown in FIG. 1—may also be used as the detection device explained above which detects the vertical position of the vertical pattern P1 and the horizontal position of the horizontal pattern P2 of the second mark 2; and, furthermore, it will also be acceptable to provide a separate detection device for detecting the second mark 2. Furthermore, there is no limitation to an alignment device which comprises a photographic element; it would also be acceptable to utilize a so called LSA method, in which a spot light which is emitted from an alignment illumination system and the alignment mark are relatively scanned, and the scattered light which is generated at the timing when the spot light illuminates the alignment mark is detected and the positional information is detected, or a so called LIA method which, by illuminating the mark with an alignment beam, causes interference between the diffracted light which is generated and a reference light beam, and which detects the positional information by obtaining the phase difference between the reference light beam and the diffracted light from the mark.

Furthermore, although the fact that variations of the horizontal position of the vertical pattern P1 and of the vertical position of the horizontal pattern P2 are related to the resolving power of the detection device has already been discussed, if the desired resolving power is not obtained by the alignment optical system which comprises the photographic element due to the influence of processes such as so called mark low level differences and the like, it sometimes happens that the desired resolving power can be obtained by making good use of the gain adjustment function of the photographic element, in other words, of the function of varying the amplitude of the signal which is generated from the photographic element. Moreover, if an alignment device is utilized which is endowed with the function of varying the wavelength of the alignment light which illuminates the alignment marks according to the characteristics of the resist which is applied to the wafer, then it will also be acceptable to take good advantage of this wavelength changeover function when detecting the second marks 2. As described above, by varying the detection conditions when detecting the second mark 2 according to the influence of processes and the characteristics of the resist, it becomes possible to obtain a higher resolving power with the detection device, and accordingly it is possible to increase the variation of the horizontal position of the vertical pattern P1, and the variation of the vertical position of the horizontal pattern P2, of this embodiment, and it becomes possible to express a greater amount of information.

It should be understood that although, in FIGS. 23A through 23E, an example was explained in which four second mark regions were provided in the vicinity of the alignment mark region 1, it is desirable for this to be made to correspond to the CMP processing which was explained in the ninth embodiment, discussed above. However, if no CMP processing is included in the device manufacturing process, it is not absolutely necessary to make sure of the presence of four of the second mark regions in the vicinity of the alignment mark region 1, and it would be acceptable to provide from one to three of the second mark regions in the vicinity of the alignment mark region 1.

Yet further, although in FIGS. 23A through 23E one each of the marks consisting of the vertical pattern P1 and the horizontal pattern P2 were displayed within the second mark region as the second marks, it would also be acceptable to utilize marks which included two or more of the vertical patterns (or of the horizontal patterns).

The Application of the Tenth Embodiment to the Search Mark

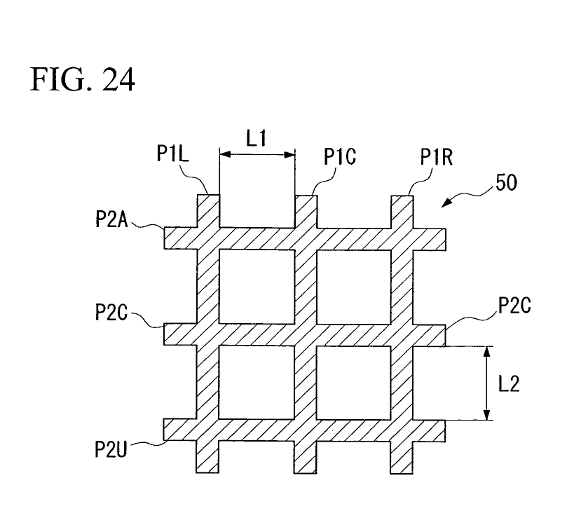

Now, as the search mark which was previously described in the section relating to the prior art, a mark such as shown, for example, in FIG. 24 may be utilized. It is possible to apply the concept of this tenth embodiment with this search mark.

The search mark 50 includes three vertical patterns P1L, P1C, and P1R which extend in the vertical direction so as to be mutually parallel to one another, and two horizontal patterns P2A, P2C, and P2U which extend in the horizontal direction so as to be mutually parallel to one another, and is made so as to define 9 intersection points in which the three vertical patterns and the three horizontal patterns overlap with one another. Among these vertical patterns which extend in the vertical direction so as to be mutually parallel to one another, the central pattern P1C may be positioned at any desired position between the left and right vertical patterns P1L and P1R, and, among the horizontal patterns which extend in the horizontal direction so as to be mutually parallel to one another, the central pattern P2C may be positioned at any desired position between the left and right vertical patterns P2A and P2U. And, by establishing a correspondence between different items of information and the position of each of the intersection points, it is possible to indicate a large number of items of information, in the same way as with the tenth embodiment described above.

Although this idea has already been described for the prior art, in order to prevent detection errors for the search mark, a forbidden zone is provided in which formation of the same type of pattern in the vicinity of the search mark is prohibited, and, by applying the concept of the tenth embodiment as described above to the search mark, and making the position of the intersection point of the vertical pattern P1C and the horizontal pattern P2C to be different for each layer, it becomes possible to identify the search mark which must be detected.

### Eleventh Embodiment

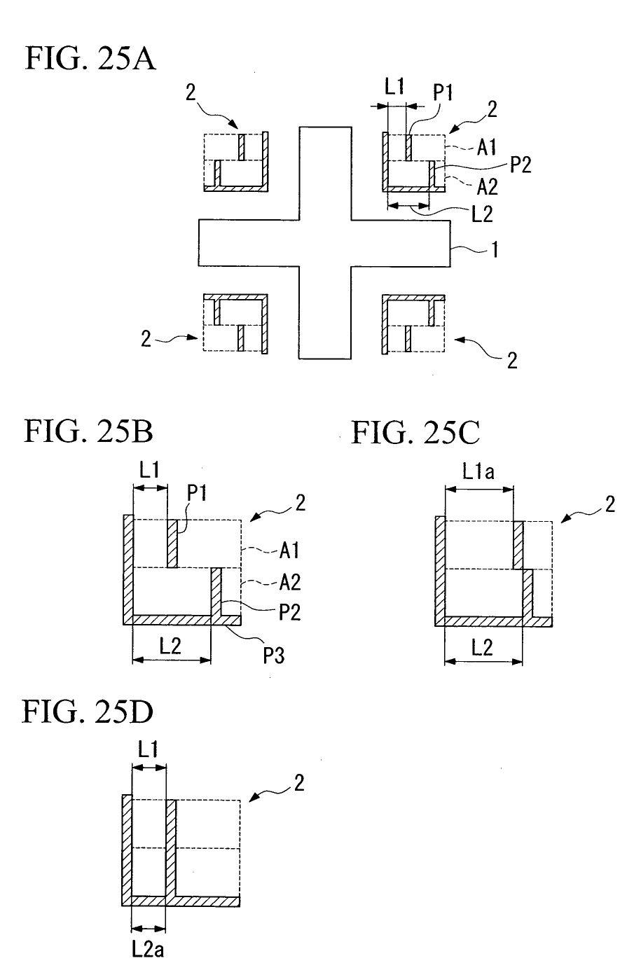

Next, the eleventh embodiment of the present invention will be explained with reference to FIGS. 25A through 25D.

As shown in FIG. 25A, in the vicinity of the alignment mark region 1, there is provided a second mark region, in a predetermined positional relationship with the alignment mark region 1, which is made up from a first separated region A1 and a second separated region A2; and this second mark 2 is formed to be made up from a first pattern portion P1 which extends in the vertical direction within this first separated region A1, and a second pattern portion P2 which extends in the vertical direction within the second separated region A2. Furthermore, in the same manner as in the tenth embodiment, a partition pattern P3 is also formed in order to protect the first mark.

In the following, the method of displaying information will be explained in relation to the second mark which is positioned at the upper right of the drawing paper in FIG. 25A, while referring to FIGS. 25B through 25D.

With the second mark 2 shown in FIG. 25B, the first pattern portion P1 is arranged at a position of length L1 from the left end portion in the figure of the first separated region A1, and furthermore the second pattern portion P2 is arranged at a position of length L2 from the left end portion in the figure of the first separated region A2. With the second mark 2 shown in FIG. 25C, the second pattern portion P2 is arranged at a position of length L2 from the left end portion in the figure of the first separated region A2, just as in FIG. 25B; but the first pattern portion P1 is arranged at a position of length L1a, which is greater than in FIG. 25B, from the left end portion in the figure of the first separated region A1. With the second mark 2 shown in FIG. 25D, the first pattern portion P1 is arranged at a position of length L1 from the left end portion in the figure of the first separated region A2, just as in FIG. 25B; but the second pattern portion P2 is arranged at a position of length L2a, which is shorter than in FIG. 25B, from the left end portion in the figure of the second separated region A2.

As described above, by making one or both of the horizontal position of the first pattern portion within the first separated region A1 and the horizontal portion of the second pattern portion P2 within the second separated region A2 to be different, it becomes possible to display a large number of items of information, equal to the number of combinations of the horizontal position of the first pattern P1 and the horizontal position of the second pattern P2. Accordingly, in the same manner as in the tenth embodiment described above, as compared with a identification mark which utilizes a bit mark, it becomes possible to make a great leap forward in increasing the number of items of information which can be displayed.

Furthermore, with the second mark of the tenth embodiment described above, it was necessary to detect the horizontal position within the second mark region for the vertical pattern portion, and to detect the vertical position within the second region for the horizontal pattern portion. However, there are some detection devices used in photographic elements which can only detect positional information in one direction. Granted that this type of detection device is used, when performing detection of the second mark of the tenth embodiment shown in FIGS. 23A through 23E, there comes to be required a process of so called relative rotation of the substrate upon which the mark is formed and the detection device, so that, after having detected the horizontal position of the vertical pattern portion, the horizontal position of the horizontal pattern portion may be detected after having relatively rotated the substrate and the detection device.

By contrast to this, with the second mark 2 of the eleventh embodiment shown in FIGS. 25 through 25D, since, for both the first pattern portion and the second pattern portion, it will be sufficient to detect their horizontal positions, accordingly there is no requirement for any process of relative rotation of the substrate and the detection device, and a contribution is also made to the enhancement of throughput.

Furthermore although, in the above explanation of the embodiment, a structure has been explained in which, after mainly having specified the detection subject mark, the subsequent procedures such as positional alignment and so on are performed by using the positional information of the mark which has been specified; but the present invention is not to be considered as being limited thereby; a structure would also be acceptable such as, for example, one in which, after having detected a specified mark, positional information was detected from that specified mark for a different mark from the specified mark which was in a predetermined positional relationship thereto, and the subsequent procedures were performed using the positional information for that different mark.

Furthermore, it is also possible to utilize the embodiments explained above in combination. For example, along with providing a identification mark 2 which is made up from bit marks 30 in the vicinity of the alignment mark 1 of the second embodiment, it would also be acceptable to arrange the identification mark 2 along the extension of the direction of extension of the pattern portion of the alignment mark 1 of the fourth embodiment. Yet further, if the pattern information of the circuit pattern portion which is formed in the shot region is combined, it becomes possible to display even more types of information.

It should be understood that, as the exposure device EX of this embodiment, apart from an exposure device of the scanning type which exposes the pattern upon the mask M to light by shifting the mask M and the photosensitive substrate P in synchronism, it would also be possible to apply the present invention to an exposure device of the step and repeat type, which exposes the pattern upon the mask M in a state in which the mask M and the photosensitive substrate P have both been stopped, and which successively step shifts the photosensitive substrate P. Furthermore, as the exposure device and the mark for position detection of this embodiment, it would also be possible to apply the present invention to a proximity exposure device which exposes the pattern upon the mask M to light by closely contacting together the mask M and the photosensitive substrate P without employing any projection optical system PL.

The utility of the exposure device EX is not limited to the exposure device for manufacturing semiconductors; it could also be applied in a wide context—for example, to an exposure device for a liquid crystal which exposes a liquid crystal display element pattern upon a square glass plate to light, or to an exposure device for manufacturing a thin film magnetic head.

As the projection optical system PL, it will be acceptable, if far ultraviolet light such as that from an excimer laser or the like is used, to utilize a material which is transparent to far ultraviolet rays such as quartz or fluorite or the like as the nitrate??; if an F2 laser or an X-ray beam is used, to utilize an optical system of the reflection-refraction type or of the refraction type (for the mask, a reflection type is also used); or, if an electron beam is used, to utilize an electronic optical system consisting of an electronic lens and a deflector as the optical system. It will be understood that it is not necessary to state that the optical path which the electron beam traverses is brought to the vacuum state.

If linear motors are used for the substrate stage PST and/or the mask stage MST, it will also be acceptable to utilize either an air floating type which uses air bearings, or a magnetic floating type which uses Lorentz force or reactance force. Furthermore, for the stage, either a type which shifts along guides, or a guideless type in which no guides are provided, is also acceptable.

If a planar motor is utilized as the drive device for the stage, either one of the magnetic unit (the permanent magnet) and the armature unit may be connected to the stage, and the other of the magnetic unit and the armature unit may be provided to the shift surface side (the base) of the stage.

The reaction force which is generated by the shifting of the substrate stage PST, as is described in Japanese Unexamined Patent Application, First Publications No. Hei 8-166475, may be allowed to escape to the floor (the ground) mechanically using a frame member. The present invention may also be applied to an exposure device which has this type of structure.

The reaction force which is generated by the shifting of the mask stage MST, as is described in Japanese Unexamined Patent Application, First Publications No. Hei 8-330224, may also be allowed to escape to the floor (the ground) mechanically using a frame member. The present invention may also be applied to an exposure device which has this type of structure.

As described above, with the exposure device of the embodiment of the present application, each type of sub-system, including each mechanical element which is enumerated in the scope of the claims of this patent, is manufactured by assembly so as to preserve a predetermined mechanical accuracy, electrical accuracy, and optical accuracy. In order to ensure these various types of accuracy, before and after this assembly, adjustment is performed in order to arrive at optical accuracy for the various optical systems, adjustment is performed in order to arrive at mechanical accuracy for the various mechanical systems, and adjustment is performed in order to arrive at electrical accuracy for the various electrical systems. The process of assembly from the various sub-systems to the exposure device includes, between the various types of sub-system, mechanical connection, wiring connection of the electrical circuitry, conduit connection of air pressure circuits, and the like. It goes without saying that, before the process of assembly from these various types of sub-system to the exposure device, there is a process of assembling each of the sub-systems. When the process of assembly from these various types of sub-system to the exposure device has been completed, overall adjustment is performed, and thereby the various types of accuracy as an integrated exposure device are assured. It should be understood that it is desirable to perform the manufacture of the exposure device in a clean room in which the temperature and the degree of cleanliness are appropriately managed.

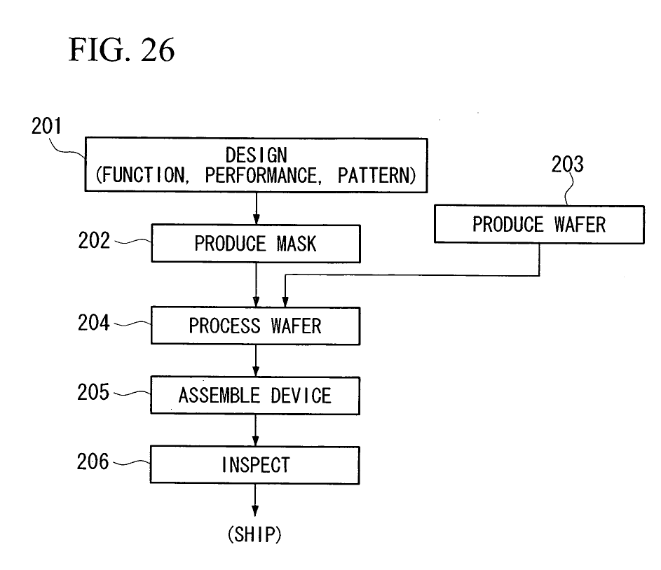

As shown in FIG. 26, a semiconductor device is manufactured via: a step 201 in which the design of the function of the device and performance design are performed; a step 202 in which, based upon this design step, a mask is manufactured; a step 203 in which a substrate, which is the base material, is manufactured; a substrate processing step 204 in which the pattern upon the mask is exposed to light onto the photosensitive substrate by an exposure device of the above described embodiments; a step 205 of assembly of the device (including a dicing process, a bonding process, and a package process); a step 206 of checking, and the like.

1. A mark for position detection, which is provided upon an object, and which is used when detecting positional information of the object with a position detection device, comprising:
a first pattern for outputting the positional information to the position detection device by being observed by the position detection device; and
a second pattern which is arranged in a predetermined positional relationship with respect to the first pattern, and which consists of n patterns (where n=1) of N types (where N=2) combined, thus expressing Nⁿ types of information.

2. A mark for position detection, which is provided upon an object, and which is used when detecting positional information of the object with a position detection device, comprising:
a first pattern for outputting the positional information to the position detection device by being observed by the position detection device; and
a second pattern which is arranged in a predetermined positional relationship with respect to the first pattern, and which consists of n patterns (where n=2) of N types (where N=2) combined, thus expressing Nⁿ types of information.

3. A mark for position detection as described in claim 1 or claim 2, wherein the second pattern expresses Nⁿ types of information by arranging N types of pattern in each of n regions which are arranged in a predetermined positional relationship with respect to the first pattern.

4. A mark for position detection as described in claim 3, wherein, in the N types of the second pattern, one type is constituted by a pattern being absent in one of the n regions.

5. A mark for position detection as described in claim 4, wherein, based upon the number and the arrangement of the regions, from among the n regions, in which a pattern is provided, and of the regions in which no pattern is provided, the second pattern expresses 2ⁿ types of information by combining n patterns of N=2 types.

6. A mark for position detection as described in claim 4, wherein 2n types of information are expressed by combining n patterns of N=2 types, by providing a pattern in some regions among the n regions, and not providing a pattern in some regions.

7. A mark for position detection as described in claim 1 or claim 2, wherein, when the position detection device is a position detection device of an image processing method which detects the positional information by image processing an observed image of the object, the first pattern is a pattern which expresses positional information when the observed image which has been observed by the position detection device of the image processing method has been image processed.

8. A mark for position detection as described in claim 7, wherein the second pattern is a pattern which expresses Nⁿ types of information when the observed image which has been observed by the position detection device of the image processing method has been image processed.

9. A mark for position detection as described in claim 1 or claim 2, wherein the first pattern is made by periodically arranging pattern portions and space portions which extend in a first direction for a prescribed length in a second direction which is almost perpendicular with respect to the first direction.

10. A mark for position detection as described in claim 9, wherein the second pattern is arranged upon an extension of the extension direction of the first pattern.

11. A mark for position detection as described in claim 9, wherein the second pattern is a pattern which expresses Nⁿ types of information by arranging patterns of N types in n respective regions which are arranged in a predetermined positional relationship with the first pattern; and
the n regions are arranged so as to almost not to mutually overlap in relation to the first direction.

12. A mark identification method for detecting positional information of an object with a detection device, and for identifying a specific first mark from a plurality of first marks which are provided upon the object, wherein:
upon the object, along with the first marks, there is provided a second pattern which is arranged in a predetermined positional relationship with respect to the first marks, which consists of a combination of n patterns (where n=1) of N types (where N=2), and which expresses Nⁿ types of information; and
the second pattern is detected by the detection device, and the specific first mark is determined based upon information which is expressed by the second pattern.

13. A mark identification method for detecting positional information of an object with a detection device, and for identifying a specific first mark from a plurality of first marks which are provided upon the object, wherein:
upon the object, along with the first mark, there is provided a second pattern which is arranged in a predetermined positional relationship with respect to the first mark, which consists of a combination of n patterns (where n=2) of N types (where N=2), and which expresses Nⁿ types of information; and
the second pattern is detected by the detection device, and the specific first mark is determined based upon information which is expressed by the second pattern.

14. A mark identification method as described in claim 12 or claim 13, wherein, as the second pattern which is provided upon the object, a pattern is provided which expresses Nⁿ types of information by arranging N types of pattern in each of n regions which are arranged in a predetermined positional relationship with respect to the first mark.

15. A mark identification method as described in claim 14, wherein, in the N types of the second pattern, one type is constituted by a pattern being absent in one of the n regions.

16. A mark identification method as described in claim 15, wherein, as the second pattern, based upon the number and the arrangement of the regions, from among the n regions, in which a pattern is provided, and of the regions in which no pattern is provided, there is provided a pattern which expresses 2n types of information by combining n patterns of N=2 types.

17. A mark identification method as described in claim 15, wherein, as the second pattern, there is provided a pattern which expresses 2ⁿ types of information by combining n patterns of N=2 types, by providing a pattern in some of the n regions, and not providing a pattern in some regions.

18. A position detection method which, by detecting a specific first mark which has been determined by a mark identification method as described in any one of claims 12 through 17 with the detection device, detects the positional information for the object.

19. An exposure method which transcribes a prescribed pattern onto a substrate, wherein:
upon the substrate, there are provided a first pattern for detection of positional information by a position detection device, and:
a second pattern which is arranged in a predetermined positional relationship with respect to the first pattern, and which consists of n patterns (where n=1) of N types (where N=2) combined, thus expressing Nⁿ types of information;
the second pattern is detected by the detection device, and, based upon the information expressed by the second pattern, the positional information is detected from the first pattern; and
based upon the positional information which has been detected, the substrate and the prescribed pattern are shifted relatively to one another, and the prescribed pattern is transcribed onto the substrate.

20. An exposure method which transcribes a prescribed pattern onto a substrate, wherein:
upon the substrate, there are provided a first pattern for detection of positional information by a position detection device, and:
a second pattern which is arranged in a predetermined positional relationship with respect to the first pattern, and which consists of n patterns (where n=2) of N types (where N=2) combined, thus expressing Nⁿ types of information;
the second pattern is detected by the detection device, and, based upon the information expressed by the second pattern, the positional information is detected from the first pattern; and
based upon the positional information which has been detected, the substrate and the prescribed pattern are shifted relatively to one another, and the prescribed pattern is transcribed onto the substrate.

21. An exposure method as described in claim 19 or claim 20, wherein, as the second pattern, there is provided a pattern which expresses Nⁿ types of information by arranging N types of pattern in each of n regions which are arranged in a predetermined positional relationship with respect to the first pattern.

22. An exposure method as described in claim 21, wherein, in the N types of the second pattern, one type is constituted by a pattern being absent in one of the n regions.

23. An exposure method as described in claim 22, wherein, as the second pattern, there is provided a pattern which, based upon the number and the arrangement of the regions, from among the n regions, in which a pattern is provided, and of the regions in which no pattern is provided, the second pattern expresses 2ⁿ types of information by combining n patterns of N=2 types.

24. An exposure method as described in claim 22, wherein, as the second pattern, there is provided a pattern which expresses 2ⁿ types of information by combining n patterns of N=2 types, by, among the n regions, providing a pattern in some regions, and not providing a pattern in some regions.

25. An exposure method as described in claim 19 or claim 20, including a process of forming a layered construction upon the substrate, and wherein:
along with forming the first pattern and the second pattern for each layer, the second pattern is provided so as that the information which is expressed by the second pattern is different for each layer.

26. An exposure method as described in any one of claim 19 through claim 25, wherein the detection device detects the positional information by image processing an observed image of the first pattern.

27. An exposure method which transcribes a prescribed pattern onto a substrate, wherein:
upon the substrate, there are provided a first pattern and a second pattern which is in a predetermined positional relationship with respect to the first pattern, and, among a plurality of marks formed upon the substrate:
relative positional information for the first pattern and the second pattern of specified marks is detected;
based upon the relative positional information, positional information for another mark, among the plurality of marks formed upon the substrate, which is different from the specified mark is determined; and
based upon the positional information which has been determined, the substrate and the prescribed pattern are shifted relatively to one another, and the prescribed pattern is transcribed onto the substrate.

28. An exposure method as described in claim 27, wherein, by detecting the relative positional information of the first pattern and the second pattern of the specified mark, information is detected related to the deformation of the substrate from the time point at which the first pattern and the second pattern were formed upon the substrate, to the detection of the relative positional information, and positional information for the other mark is determined, based upon the deformation information.

29. An exposure method as described in claim 27, wherein by detecting the relative positional information of the first pattern and the second pattern of the specified mark, at least one is determined of the amount of change of the distance between the first pattern and the second pattern, and the amount of rotation of the substrate with respect to a prescribed direction, from the time point at which the first pattern and the second pattern were formed upon the substrate, to the detection of the relative positional information.

30. An exposure method as described in any one of claim 27 through claim 29, wherein the first pattern is a pattern for detecting positional information in the position detection device; and:
the second pattern is a pattern which consists of n patterns (where n=1) of N types (where N=2) combined, thus expressing Nⁿ types of information.

31. An exposure method as described in any one of claim 27 through claim 29, wherein the first pattern is a pattern for detecting positional information in the position detection device, and:
the second pattern is a pattern which consists of n patterns (where n=2) of N types (where N=2) combined, thus expressing Nⁿ types of information.

32. A mark detection method in which, using a mark detection device of an image processing method which has a predetermined measurement region, a second mark is detected from upon an object upon which are formed a first mark and the second mark which is in a predetermined positional relationship with respect to the first mark and which is smaller than the first mark, in which:
an image of the measurement region is photographed and image data is acquired;
the image data is subjected to compression processing;
positional information for the first mark is detected from the image data which has been compression processed; and
based upon the positional information for the first mark which has been detected, and relative positional information for the first mark and the second mark, positional information for the second mark is detected from the image data for the measurement region which have been photographed.

33. An exposure method in which, using a mark detection device of an image processing method which has a predetermined measurement region, a second mark is detected from upon a substrate upon which are formed a first mark and the second mark which is in a predetermined positional relationship with respect to the first mark and which is smaller than the first mark, and, after having performed positional alignment of the mask and the substrate, a pattern upon the mask is exposed to light onto the substrate, in which:
an image of the measurement region is photographed and image data is acquired;
the image data is subjected to compression processing;
positional information for the first mark is detected from the image data which has been compression processed; and
based upon the positional information for the first mark which has been detected, and relative positional information for the first mark and the second mark, positional information for the second mark is detected from the image data for the measurement region which have been photographed.

34. A mark detection method which detects marks upon an object using a mark detection device which has a predetermined measurement region, wherein:
non subject marks are provided at almost equal spacing in the vicinity of the subject mark which is the subject of detection, and the subject mark is detected.

35. An exposure method in which marks upon a substrate are detected using a mark detection device which has a predetermined measurement region, and a pattern of a mask is exposed to light onto the substrate while positionally aligning the mask and the substrate, in which non subject marks are provided at almost equal spacing in the vicinity of the subject mark which is the subject of detection, and the subject mark is detected.

36. A positional information detection method, in which a subject mark which is formed upon an object is detected using a mark detection device which detects the mark by a prescribed detection method, and, based upon the detection result, positional information for the object is detected, wherein:
a non subject mark which is formed upon the object in a predetermined positional relationship with the subject mark, and of which the ease of detection by the prescribed detection method is high, is detected by the mark detection device;
based upon the detection result of the non subject mark, and the predetermined positional relationship, the subject mark is detected by the mark detection device; and:
based upon the detection result for the subject mark, positional information for the object is detected.

37. A positional information detection method as described in claim 36, wherein the non subject mark for which the ease of detection is high has a greater area than the subject mark.

38. A positional information detection method as described in claim 36, wherein:
the mark detection device is a mark detection device which detects a mark with an image processing method; and
when the non subject mark for which the ease of detection is high is photographed with the mark detection device, the scattering value of the image data is low.

39. A mark which is formed upon an object, and which is used for detection of positional information of the object, wherein:
the mark is formed as being arranged in a desired position within a predetermined mark region which is ensured upon the object; and
information is expressed by the position of the mark within the mark region.

40. A mark as described in claim 39, comprising:
a vertical pattern portion which extends within the mark region in a first direction; and
a horizontal pattern portion which extends within the mark region in a second direction which intersects the first direction; and wherein:
the information is expressed by the position of the intersection point between the vertical pattern portion and the horizontal pattern portion.

41. A mark as described in claim 39, comprising a pattern portion which extends in a first direction within the mark region, and wherein:
the information is expressed based upon the position related to the second direction of the pattern portion within the mark region which intersects the first direction.

42. A mark as described in claim 39, comprising:
a first pattern portion which extends in a first direction within a first separated region, which is one region into which the interior of the second region has been separated at a prescribed position in the first direction; and
a second pattern portion which extends in the first direction within a second separated region, which is the other region into which the interior of the second region has been separated at the prescribed position in the first direction; and wherein:
the positional information is expressed based upon both of:
the position of the first pattern portion within the first separated region related to a second direction which intersects the first direction; and
the position of the second pattern portion within the second separated region relating to the second direction which intersects the first direction.

43. A mark which is formed upon an object, and which is used for detection of positional information for the object:
including a first mark region and a second mark region which is in a predetermined positional relationship with the first mark region; and wherein:
a first mark is formed within the first mark region for detecting positional information for the object;
a second mark is formed within the second mark region and is arranged at a desired position within the second mark region; and
information related to the first mark is expressed based upon the position of the second mark within the second mark region.

44. A mark as described in claim 43 which is formed in a plurality upon the object, and wherein:
information related to the first mark is expressed based upon the position of the second mark within the second mark region; and
it is information for deciding whether the first mark which is in the predetermined positional relationship with respect to the second mark region is a detection subject mark, or is a mark other than a detection subject.

45. A mark as described in claim 43, formed in a plurality upon the object, and formed upon each layer of the plurality of layers; and wherein:
the information related to the first mark which is expressed based upon the positional information for the second mark within the second mark region is information related to the layer upon which the first mark is formed.

46. A mark as described in claim 43, wherein the second mark comprises:
a vertical pattern portion which extends within the second region in a first direction; and
a horizontal pattern portion which extends within the second region in a second direction which intersects the first direction; and wherein:
the information which is related to the first mark is expressed by the position of the intersection point between the vertical pattern portion and the horizontal pattern portion.

47. A mark as described in claim 43, wherein the second mark comprises a pattern portion which extends within the second region in a first direction; and
the information which is related to the first mark is expressed by a position which is related to the second direction of the intersection in the first direction of the pattern portions within the second region.

48. A mark as described in claim 43, wherein the second mark comprises:
a first pattern portion which extends in the first direction within a first separated region, which is one region into which the interior of the second region has been divided at a prescribed position in the first direction;
a second pattern portion which extends in the first direction within a second separated region, which is the other of the regions into which the interior of the second region has been divided at the prescribed position in the first direction, wherein
the information related to the first mark is expressed based upon both of a position related to the second direction of the intersection in the first direction of the first pattern portion within the first separated region; and
a position related to the second direction of the intersection in the first direction of the second pattern portion within the second separated region.

49. An exposure device, which comprises a detector which detects positional information for a substrate by detecting a mark which is formed within a mark region which is made up of a first mark region and a second mark region upon the substrate, and a driver which is electrically connected to the detector, and which shifts the prescribed pattern and the substrate relatively to one another, based upon positional information for the substrate which has been detected by the detector; and which transcribes the prescribed pattern onto a substrate, wherein:
the mark which is detected by the detector comprises:
a first mark which, by being detected by the detector, generates a signal which expresses positional information for the substrate by the detector;
a second mark which is arranged at a desired position within a second mark region; and
the detector detects information related to the first mark based upon the position of the second mark within the second region.

50. An exposure device as described in claim 49, wherein
a plurality of the marks are provided upon the object; and:
the detector makes a decision as to whether the first mark which is in the predetermined positional relationship with respect to the second mark region is a detection subject mark, or is a mark other than a detection subject, based upon positional information for the second mark within the second mark region.

51. An exposure device as described in claim 49, wherein:
a plurality of layers are formed upon the object;
the mark is formed for each of the plurality of layers, and:
the detector detects information related to the layer upon which the first mark is formed, based upon positional information for the second mark within the second mark region.

52. An exposure device as described in claim 49, wherein the second mark comprises:
a vertical pattern portion which extends within the second region in a first direction; and
a horizontal pattern portion which extends within the second region in a second direction which intersects the first direction,
wherein the detector detects information which is related to the first mark, based upon the position of the intersection point between the vertical pattern portion and the horizontal pattern portion.

53. An exposure device as described in claim 49, wherein:
the second mark comprises a pattern portion which extends within the second region in a first direction; and
the detector detects information which is related to the first mark, based upon a position which is related to the second direction of the intersection in the first direction of the pattern portion within the second region.

54. An exposure device as described in claim 49, wherein the second mark comprises:
a first pattern portion which extends in the first direction within a first separated region, which is one region into which the interior of the second region has been divided at a prescribed position in the first direction;
a second pattern portion which extends in the first direction within a second separated region, which is the other of the regions into which the interior of the second region has been divided at the prescribed position in the first direction; and
the detector detects the information related to the first mark based upon both of a position related to the second direction of the intersection in the first direction with the first pattern portion within the first separated region, and a position related to the second direction of the intersection in the first direction with the second pattern portion within the second separated region.

55. An exposure device as described in claim 49, wherein the detector varies the conditions of detection when detecting the mark, according to the conditions when the mark was formed.

56. An exposure device as described in claim 55, wherein the detector comprises an illumination system which irradiates a detection beam onto the mark, and wherein the wavelength of the detection beam is varied according to the conditions when the mark was formed.

57. An exposure device as described in claim 55, wherein the detector comprises an adjustment means which varies the amplitude of the signal which is generated by detection of the mark, and the amplitude of the signal is varied according to the conditions when the mark was formed.

58. An exposure device as described in claim 56, wherein the detector comprises a photographic element, and the mark is detected by an image of the mark being photographed by the photographic element.

59. An exposure method for transcribing a prescribed pattern onto a substrate, comprising:
a process of detecting positional information for the substrate by detecting a mark which is formed within a mark region which is made up of a first mark region and a second mark region upon the substrate; and
a process of, based upon positional information for the substrate which has been detected by the detector, shifting the prescribed pattern and the substrate relatively to one another and exposing the prescribed pattern to light; wherein:
the mark is a mark which comprises a first mark which causes a position signal for the substrate to be generated by being detected by the detection process, and a second mark which is formed in a desired position within the second mark region, and which expresses information which is related to the first mark by its position within the second mark region; and
information which is related to the first mark is detected based upon the position of the second mark within the second mark region.

60. An exposure method as described in claim 59, wherein:
a plurality of the marks are provided upon the object; and
a decision is made, in the process of detecting positional information for the substrate, as to whether the first mark which is in the predetermined positional relationship with respect to the second mark region is a detection subject mark, or is a mark other than a detection subject, based upon positional information for the second mark within the second mark region.

61. An exposure method as described in claim 59, wherein:
a plurality of layers are formed upon the object;
the mark is formed for each of the plurality of layers, and:
in the process of detecting positional information for the substrate, information related to the layer upon which the first mark is formed is detected, based upon positional information for the second mark within the second mark region.

62. An exposure method as described in claim 59, wherein the second mark comprises:
a vertical pattern portion which extends within the second region in a first direction; and
a horizontal pattern portion which extends within the second region in a second direction which intersects the first direction; and wherein:
in the process of detecting positional information for the substrate, information is detected which is related to the first mark, based upon the position of the intersection point between the vertical pattern portion and the horizontal pattern portion.

63. An exposure method as described in claim 59, wherein:
the second mark comprises a pattern portion which extends within the second region in a first direction; and
in the process of detecting the position of the substrate, information is detected which is related to the first mark, based upon a position which is related to the second direction of the intersection in the first direction of the pattern portion within the second region.

64. An exposure method as described in claim 59, wherein the second mark comprises:
a first pattern portion which extends in the first direction within a first separated region, which is one region into which the interior of the second region has been divided at a prescribed position in the first direction; and
a second pattern portion which extends in the first direction within a second separated region, which is the other of the regions into which the interior of the second region has been divided at the prescribed position in the first direction,
wherein, in the process of detecting the position of the substrate, information is detected related to the first mark based upon both of a position related to the second direction of the intersection in the first direction with the first pattern portion within the first separated region, and a position related to the second direction of the intersection in the first direction with the second pattern portion within the second separated region.

65. An exposure method as described in claim 59, wherein, in the process of detecting the position of the substrate, the conditions of detection are varied when detecting the mark, according to the conditions when the mark was formed.

66. An exposure method as described in claim 59, wherein the process of detecting the position of the substrate includes irradiating a detection beam onto the mark, and wherein the wavelength of the detection beam is varied according to the conditions when the mark was formed.

67. An exposure method as described in claim 59, wherein the process of detecting the position of the substrate includes varying the amplitude of the signal which is generated by detection of the mark, and the amplitude of the signal is varied according to the conditions when the mark was formed.

68. An exposure method as described in claim 59, wherein, in the process of detecting the position of the substrate, the mark is detected by an image of the mark being photographed by a photographic element.

69. A device manufacturing method, including a process of transcribing a device pattern onto a substrate which uses an exposure method as described in any one of claims 59 through claim 68.

70. A device which has been manufactured by a device manufacturing method as described in claim 69.

71. A method of manufacturing an exposure device which exposes a prescribed pattern onto a substrate, wherein:
there is provided a detector which detects positional information for the substrate by detecting a mark which is formed in a mark region which consists of a first mark region and a second mark region upon the substrate;
there is also provided a driver which shifts the substrate to a position in which the substrate is presented for exposure to light, based upon positional information for the substrate which has been detected by the detector; and
the mark is a mark which comprises:
a first mark which causes a signal which expresses positional information for the substrate to be generated by the detector, by being detected by the detector; and
a second mark which is arranged in a desired position within the second mark region, wherein
the detector detects information which is related to the first mark based upon the position of the second mark within the second region.

72. A method of manufacturing an exposure device as described in claim 71, wherein:
a plurality of the marks are provided upon the object; and:
the detector decides, based upon positional information for the second mark within the second mark region, as to whether the first mark which is in the predetermined positional relationship with respect to the second mark region is a detection subject mark, or is a mark other than a detection subject.

73. A method of manufacturing an exposure device as described in claim 71, wherein:
a plurality of layers are formed upon the object;
the mark is formed for each of the plurality of layers, and:
the detector detects information related to the layer upon which the first mark is formed is detected, based upon positional information for the second mark within the second mark region.

74. A method of manufacturing an exposure device as described in claim 71, wherein the second mark comprises:
a vertical pattern portion which extends within the second region in a first direction; and
a horizontal pattern portion which extends within the second region in a second direction which intersects the first direction, wherein the detector detects information which is related to the first mark, based upon the position of the intersection point between the vertical pattern portion and the horizontal pattern portion.

75. A method of manufacturing an exposure device as described in claim 71, wherein:
the second mark comprises a pattern portion which extends within the second region in a first direction; and
the detector is made so as to detect information which is related to the first mark, based upon a position which is related to the second direction of the intersection in the first direction of the pattern portion within the second region.

76. A method of manufacturing an exposure device as described in claim 71, wherein second mark comprises:
a first pattern portion which extends in the first direction within a first separated region, which is one region into which the interior of the second region has been divided at a prescribed position in the first direction;
a second pattern portion which extends in the first direction within a second separated region, which is the other of the regions into which the interior of the second region has been divided at the prescribed position in the first direction; and
the detector detects information related to the first mark based upon both of a position related to the second direction of the intersection in the first direction of the first pattern portion within the first separated region, and a position related to the second direction of the intersection in the first direction of the second pattern portion within the second separated region.

77. A method of manufacturing an exposure device as described in claim 71, wherein the detector varies the conditions of detection when detecting the mark, according to the conditions when the mark was formed.

78. A method of manufacturing an exposure device as described in claim 71, wherein the detector comprises an illumination system which irradiates a detection beam onto the mark, and wherein the wavelength of the detection beam is varied according to the conditions when the mark was formed.

79. A method of manufacturing an exposure device as described in claim 71, wherein the detector comprises an adjustment means which varies the amplitude of the signal which is generated by detection of the mark, and the amplitude of the signal is varied according to the conditions when the mark was formed.

80. A method of manufacturing an exposure device as described in claim 71, wherein the detector comprises a photographic element, and the mark is detected by an image of the mark being photographed by the photographic element.

81. A mark which is formed upon an object, and which is used for detection of positional information of the object, comprising:
a vertical pattern portion which extends in a first direction within a predetermined mark region which is ensured upon the object; and
a horizontal pattern portion which extends within the mark region in a second direction which intersects the first direction, wherein
the information is expressed by the position of the intersection point between the vertical pattern portion and the horizontal pattern portion.

82. A mark which is formed upon an object, and which is used for detection of positional information of the object, comprising:
a first mark region and a second mark region which is in a predetermined positional relationship with respect to the first mark region, wherein
a first mark for detecting positional information for the object is formed within the first mark region; and
a second mark which is arranged in a desired position within the second mark region is formed within the second mark region; and
the second mark comprises:
a vertical pattern portion which extends in a first direction within the second region; and
a horizontal pattern portion which extends within the second region in a second direction which intersects the first direction; and wherein
information related to the first pattern is expressed by the position of the intersection point between the vertical pattern portion and the horizontal pattern portion.

83. An exposure device which comprises a detector which detects positional information for a substrate by detecting a mark which is formed within a mark region which is made up of a first mark region and a second mark region upon the substrate, and a driver which is electrically connected to the detector, and which shifts the prescribed pattern and the substrate relatively to one another, based upon positional information for the substrate which has been detected by the detector; and which transcribes the prescribed pattern onto a substrate, wherein:
the mark which is detected by the detector comprises:
a first mark which, by being detected by the detector, generates a signal which expresses positional information for the substrate to the detector; and
a second mark which comprises a vertical pattern portion which extends within the second region in a first direction, and a horizontal pattern portion which extends within the second region in a second direction which intersects the first direction; and wherein:
the detector detects information which is related to the first mark, based upon the position of the intersection point between the vertical pattern portion and the horizontal pattern portion of the second mark.

84. An exposure method for transcribing a prescribed pattern onto a substrate, comprising:
a process of detecting positional information for the substrate by detecting a mark which is formed within a mark region which is made up of a first mark region and a second mark region upon the substrate; and
a process of shifting the prescribed pattern and the substrate relatively to one another, based upon positional information for the substrate which has been detected by the detector, and exposing the prescribed pattern to light; wherein
the mark comprises:
a first mark which, by being detected by the detection process, generates a position signal for the substrate; and
a second mark which comprises a vertical pattern portion which extends within the second region in a first direction, and a horizontal pattern portion which extends within the second region in a second direction which intersects the first direction, wherein:
information which is related to the first mark is detected, based upon the position of the intersection point between the vertical pattern portion and the horizontal pattern portion.

85. A device manufacturing method which includes a process of transcribing a device pattern onto a substrate which utilizes the exposure method described in claim 84.

86. A device manufactured by the device manufacturing method described in claim 85.

87. A method of manufacturing an exposure device which exposes a prescribed pattern onto a substrate, wherein:
there is provided a detector which detects positional information for the substrate by detecting a mark which is formed in a mark region which consists of a first mark region and a second mark region upon the substrate;
there is also provided a driver which shifts the substrate to a position in which the substrate is presented for exposure, based upon positional information for the substrate which has been detected by the detector; and
the mark is a mark which comprises:
a first mark which causes a signal which expresses positional information for the substrate to be generated by the detector, by being detected by the detector; and
a second mark which comprises a vertical pattern portion which extends within the second region in a first direction; and a horizontal pattern portion which extends within the second region in a second direction which intersects the first direction, wherein the detector detects information which is related to the first pattern, based upon the position of the intersection point between the vertical pattern portion and the horizontal pattern portion.

88. A mark which is formed upon an object, and which is used for detection of positional information for the object comprising:
a pattern portion which extends within the mark region in a first direction, wherein the information is expressed based upon a position which is related to the second direction of the intersection in the first direction of the pattern portion within the mark region.

89. A mark as described in claim 88, wherein the second mark comprising:
a first pattern portion which extends in the first direction within a first separated region, which is one region into which the interior of the second region has been divided at a prescribed position in the first direction; and
a second pattern portion which extends in the first direction within a second separated region, which is the other of the regions into which the interior of the second region has been divided at the prescribed position in the first direction, wherein
the positional information is expressed based upon both of a position related to the second direction of the intersection in the first direction of the first pattern portion within the first separated region; and
a position related to the second direction of the intersection in the first direction of the second pattern portion within the second separated region.

90. A mark which is formed upon an object, and which is used for detection of positional information for the object comprising:
a first mark region and a second mark region which is in a predetermined positional relationship with respect to the first mark region;
a first mark which is formed within the first mark region, and which is used for detecting positional information for the object; and
a second mark which comprises a pattern portion which extends in a first direction within the second region, and which expresses information which is related to the first mark according to the position related to the second direction of the pattern portion within the second region which intersects in the first direction.

91. A mark as described in claim 90, comprising:
a first pattern portion which extends in the first direction within a first separated region, which is one region into which the interior of the second region has been divided at a prescribed position in the first direction; and
a second pattern portion which extends in the first direction within a second separated region, which is the other of the regions into which the interior of the second region has been divided at the prescribed position in the first direction, wherein
the positional information is expressed based upon both of a position related to the second direction of the intersection in the first direction of the first pattern portion within the first separated region, and
a position related to the second direction of the intersection in the first direction of the second pattern portion within the second separated region.

92. An exposure device comprising:
a detector which detects positional information for a substrate by detecting a mark which is formed within a mark region which is made up of a first mark region and a second mark region upon the substrate; and
a drive section which is electrically connected to the detection section, and which shifts the prescribed pattern and the substrate relatively to one another, based upon positional information for the substrate which has been detected by the detection section; and which transcribes the prescribed pattern onto a substrate, wherein:
the mark which is detected by the detection section comprises:
a first mark which is formed in the first mark region, and which, by being detected by the detection section, generates a signal which expresses positional information for the substrate by the detection section;
a second mark which comprises a pattern portion which extends in a first direction within the second region; wherein
the detection section detects information related to the first mark, based upon the position related to the second direction of the pattern portion of the second mark within the second region.

93. An exposure device as described in claim 92, wherein the second mark comprises:
a first pattern portion which extends in the first direction within a first separated region, which is one region into which the interior of the second region has been divided at a prescribed position in the first direction; and
a second pattern portion which extends in the first direction within a second separated region, which is the other of the regions into which the interior of the second region has been divided at the prescribed position in the first direction, wherein
the detection section detects information related to the first mark, based upon both of a position related to the second direction of the intersection in the first direction of the first pattern portion within the first separated region, and a position related to the second direction of the intersection in the first direction of the second pattern portion within the second separated region.

94. An exposure method for transcribing a prescribed pattern onto a substrate comprising:
a process of detecting positional information for the substrate by detecting a mark which is formed within a mark region which is made up of a first mark region and a second mark region upon the substrate; and
a process of shifting the prescribed pattern and the substrate relatively to one another, based upon positional information for the substrate which has been detected by the detection section, and exposing the prescribed pattern to light, wherein
the mark comprises:
a first mark which, by being detected by the detection process, generates a position signal for the substrate; and
a second mark which comprises a pattern portion which extends in a first direction within the second region; wherein
by the process of detecting the positional information, information related to the first mark is detected, based upon a position which is related to the second direction of the intersection in the first direction of the pattern portion within the second region.

95. An exposure method as described in claim 94, wherein the second mark comprises:
a first pattern portion which extends in the first direction within a first separated region, which is one region into which the interior of the second region has been divided at a prescribed position in the first direction; and
a second pattern portion which extends in the first direction within a second separated region, which is the other of the regions into which the interior of the second region has been divided at the prescribed position in the first direction; and
the information related to the first mark is detected, based upon both of a position related to the second direction of the intersection in the first direction of the first pattern portion within the first separated portion, and a position related to the second direction of the intersection in the first direction of the second pattern portion within the second separated portion.

96. A device manufacturing method, including a process of transcribing a device pattern onto a substrate which utilizes an exposure method as described in claim 94 or claim 95.

97. A device which has been manufactured by a device manufacturing method as described in claim 96.

98. A method of manufacturing an exposure device which exposes a prescribed pattern onto a substrate, wherein:
there is provided a detection section which detects positional information for the substrate by detecting a mark which is formed in a mark region which consists of a first mark region and a second mark region upon the substrate;
there is also provided a drive section which shifts the substrate to a position in which the substrate is presented for exposure to light, based upon positional information for the substrate which has been detected by the detection section, wherein:
the mark comprises:
a first mark which causes a signal which expresses positional information for the substrate to be generated by the detection section, by being detected by the detection section; and
a second mark which comprises a pattern portion which extends in a first direction within the second region, and the detection section expresses information related to the first mark based upon a position which is related to the second direction of the intersection in the first direction of the pattern portion within the second region, wherein the detection section detects information which is related to the first mark based upon the position of the pattern portion within the second region.

99. A method of manufacturing an exposure device as described in claim 98, wherein the second mark comprises:
a first pattern portion which extends in the first direction within a first separated region, which is one region into which the interior of the second region has been divided at a prescribed position in the first direction; and
a second pattern portion which extends in the first direction within a second separated region, which is the other of the regions into which the interior of the second region has been divided at the prescribed position in the first direction; and
the detection section detects information related to the first mark based upon both of a position related to the second direction of the intersection in the first direction of the first pattern portion within the first separated region, and a position related to the second direction of the intersection in the first direction of the second pattern portion within the second separated region.

100. A mark which is formed on an object and provided with a subsidiary pattern comprising:
a mark for position detection which detects a position;
the subsidiary pattern which is used for identify the mark for position detection which is a target on the object on which a plurality of marks for position detection are formed.

101. A mark for position detection which is provided with:
the subsidiary pattern of claim 100;
a subsidiary pattern forming area in which the subsidiary pattern is allowed to be formed in a predetermined positional relationship with the mark for position detection, wherein the subsidiary pattern shows an information which identifies the mark for position detection as a target according to whether or not the subsidiary pattern is formed in the subsidiary pattern forming area.

102. A mark for position detection which is provided with the subsidiary pattern of claim 100 wherein the subsidiary pattern shows an information which identifies an identification mark as a target according to a shape of the subsidiary pattern.

103. An exposure method wherein:
the mark for position detection as a target is identified by using the subsidiary pattern from above the object on which the mark for position detection which is provided with the subsidiary pattern of claim 100 is formed;
a relational position between a device pattern which is projected on the object and the object is controlled according to a positional information of the object which is obtained as a result of a measurement for the mark for position detection as a target; and
a device pattern is transcribed on the object of which relational position is controlled.

104. An exposure method according to claim 103 wherein:
the subsidiary pattern has a predetermined positional relationship which is defined for the mark for position detection;
the mark for position detection is measured in a step which identifies the mark for position detection, and after that, an information which identifies the mark for position detection as a target is detected from the identified pattern by using a relational positional information of the subsidiary pattern with reference to the mark for position detection.

105. An exposure method according to claim 104 wherein:
the mark for position detection which is provided with the subsidiary pattern has a predetermined positional relationship with the mark for position detection and is provided with the subsidiary pattern forming area in which the subsidiary pattern is allowed to be formed; and
the subsidiary pattern shows an information which identifies the mark for position detection as a target according to whether or not the subsidiary pattern is formed in the subsidiary pattern forming area.

106. An exposure device which transcribes the device pattern on the object of which relative position is controlled comprising:
a detection device which detects the mark for position detection from above the object on which the mark for position detection which is provided with the subsidiary pattern of claim 1 is formed;
an identification device which identifies the mark for position detection as a target by using the subsidiary pattern;
an projection optical system which projects an image of a device pattern on the object; and
a position control device which controls the relative position between the image of the device pattern which is projected on the object and the object according to the position information of the object which is obtained as a result of a measurement for the mark for position detection as a target.

107. A device manufacturing method comprising the steps of:
identifying the mark for position detection as a target by using the subsidiary pattern from above the object on which the mark for position detection which is provided with the subsidiary pattern of claim 100 is formed;
controlling the relative position between the image of the device pattern which is projected on the object and the object according to the position information of the object which is obtained as a result of a measurement for the mark for position detection as a target; and
transcribing the device pattern on the object of which relative position is controlled.

108. An exposure method according to claim 107 wherein:
the mark for position detection which is provided with the subsidiary pattern has a predetermined positional relationship with reference to the mark for position detection and is provided with a subsidiary pattern forming area in which the subsidiary pattern is allowed to be formed; and
the subsidiary pattern shows an information which identifies the mark for position detection as a target according to whether or not the subsidiary pattern is formed in the subsidiary pattern forming area.

109. A device which is manufactured by using the device manufacturing method of claim 108.

110. A mark for position detection which is provided with the subsidiary pattern of claim 100 wherein:
the mark for position detection is provided with a plurality of pattern sections which extend to a predetermined direction and are formed periodically;
the subsidiary pattern is formed in a part of the pattern section among a plurality of the pattern sections continuously; and
the mark for position detection as a target is identified by differentiating a shape of a part of the pattern section among a plurality of the pattern sections from a shape of the other pattern sections among a plurality of the pattern sections.

111. An exposure method according to claim 107 comprising the steps of:
forming a plurality of marks for position detection according to a positional arrangement such that a positional relationship of a plurality of marks for position detection form a predetermined arrangement;
detecting the predetermined arrangement from above the object;
specifying the mark for position detection as a target among the marks for position detection which form the predetermined arrangement according to an information for the predetermined arrangement;
obtaining an information for the position of the object by using the specified information for the position for the mark for position detection as a target;
controlling the relative position between the image of the device pattern which is projected on the object and the object according to the information for the position of the object; and
transcribing the device pattern on the object of which relative position is controlled.
